(19) United States
(12) Patent Application Publication
(10) Pub. No.: US 2003/0220922 A1
(43) Pub. Date: Nov. 27, 2003

(54) Information processing apparatus and method, recording medium, and program

(76) Inventors: Noriyuki Yamamoto, Tokyo (JP); Mari Saito, Kanagawa (JP)

Correspondence Address: William S. Frommer, Esq., FROMMER LAWRENCE & HAUG LLP, 745 Fifth Avenue, New York, NY, 10151, US

(21) Appl. No.: 10/401,345

(22) Filed: Mar. 28, 2003

(30) Foreign Application Priority Data
Mar. 29, 2002 (JP) 2002-095413

(51) Int. Cl. G06F 7/00

(52) U.S. Cl. 707/7

(57) ABSTRACT

The present invention relates to an information processing apparatus. The information processing apparatus has database creating means for classifying existing document information into groups and creating a database having associated information about each of the groups; search means for searching predetermined document information for characteristic words; and presenting means for presenting, of the associated information created by the database creating means, associated information associated with the characteristic words searched by the search means. The database creating means includes: selecting means for selecting, of document information about all of the existing document information, the existing document information to be classified into the groups; classifying means for classifying the existing document information selected by the selecting means into the groups; single-out means for singling out at least one of the groups having the existing document information; acquiring means for acquiring associated information about at least one of the groups having the existing document information; and accumulating means for accumulating the associated information acquired by the acquiring means by relating the associated information with the groups.

### BACKGROUND OF THE INVENTION

The present invention relates generally to an information processing apparatus and method, a recording medium, and a program. More particularly, the present invention relates to an information processing apparatus and method, recording medium, and a program intended to store words of user's interest and the associated information acquired from documents such as electronic mail into a database and to effectively display the associated information.

Application programs are known by which a character called a desktop mascot is displayed on the desktop (or the display screen) of computers.

Such a desktop mascot is provided with functions of notifying the user of the incoming electronic mail, moving around on the desktop, or the like.

Now, in entering a document to be sent as electronic mail by a user or in browsing a received document for example, the presentation of the information associated with a document to be sent or received (this information will hereafter be referred to as associated information) to the user enhances user convenience. Moreover, having a desktop mascot execute this presentation may make the user become more attached to the mascot.

Conventionally, a method in which a database is automatically constructed by use of documents such as electronic mail, and the associated information related to the sent and received electronic mail documents is presented to the user, is disclosed in Japanese Patent Laid-open No. 2001-312515 (hereafter referred to as the prior application) for example.

However, in the invention disclosed in the abovementioned prior application, all electronic mail messages are analyzed and formed into a database without considering such personal differences in electronic mail usage as the length of time in which a particular user has been using electronic mail, the frequency of transmission/reception of electronic mail, the existence of folder groups, and the number of electronic mail partners. Consequently, the invention of the prior application presents problems of wasting the computer resources (processing time, memories, or the like) for the electronic mail analysis processing. In addition, the results of the analysis are not proper in many cases, making it impossible to present proper information to the user.

To be more specific, in the above-mentioned prior application, words corresponding to user's interest are extracted from electronic mail sentences, and the information about the extracted words is presented to the user. The method in which the words corresponding to user's interest are extracted from electronic mail sentences is actually based on an assumption that user's interest influences the occurrence frequency of the words used in sentences. In this method, morphological analysis is performed on each piece of all electronic mail or the electronic mail mainly communicated within a certain period of time to extract words, and the occurrence frequency of each of the extracted words is computed to extract the words of high occurrence frequency from each piece of electronic mail or a plurality of pieces of electronic mail communicated within a certain period of time as the words of user's interest.

However, because the above-mentioned method does not consider the personal differences in electronic mail usage status and the characteristics of electronic mail (for example, sender and receiver, and date/time of communication), the electronic mail from mailing lists which is received but not returned and the so-called spam mail for advertisement are also analyzed, thereby extracting words which are out of user's interest.

In addition, in the above-mentioned related-art method, because morphological analysis is performed on sent and received electronic mail, in a situation where no electronic mail is sent or received, no new words of user's interest are extracted, thereby presenting a problem of the inability to present new associated information to the user.

It should be noted that a method is known in which the URLs and titles of Web pages indicative of general information are registered beforehand in order to present some information to the user in a situation where no new words of user's interest are extracted. However, this method presents every time the same Web page in a situation where no new words of user's interest are extracted, thereby presenting problems of not only losing the element of surprise for the user but also the inability to track the URL of a Web page concerned if the URL is changed.

### SUMMARY OF THE INVENTION

It is therefore an object of the present invention to provide an information processing apparatus and method, a recording medium, and a program which quickly extract words of user's interest by restricting the sentences subject to analysis on the basis of the characteristics of electronic mail and present proper information to the user in a situation where a send/receive operation of electronic mail is not performed.

In carrying out the invention and according to a first aspect thereof, there is provided an information processing apparatus having:

database creating means for classifying existing document information into groups and creating a database having associated information about each of the groups;

search means for searching predetermined document information for characteristic words; and

presenting means for presenting, of the associated information created by the database creating means, associated information associated with the characteristic words searched by the search means,

the database creating means including:

selecting means for selecting, of document information about all of the existing document information, the existing document information to be classified into the groups;

classifying means for classifying the existing document information selected by the selecting means into the groups;

single-out means for singling out at least one of the groups having the existing document information;

acquiring means for acquiring associated information about at least one of the groups having the existing document information; and

accumulating means for accumulating the associated information acquired by the acquiring means by relating the associated information with the groups.

According to a second aspect of the invention, there is provided an information processing apparatus for classifying existing document information into groups and creating a database having associated information about each of the groups, the information processing apparatus including:

selecting means for selecting, of document information about all of the existing document information, the existing document information to be classified into the groups.

According to a third aspect of the invention, there is provided an information processing method for an information processing apparatus for classifying existing document information into groups and creating a database having associated information about each of the groups, including the step of:

selecting, of all of the existing document information, the existing document information to be processed for classifying into the groups.

According to a fourth aspect of the invention, there is provided a recording medium storing a computer-readable program for classifying existing document information into groups and creating a database having associated information about each of the groups, including the step of:

selecting, of all of the existing document information, the existing document information to be processed for classifying into the groups.

According to a fifth aspect of the invention, there is provided a program for having a computer for classifying existing document information into groups and creating a database having associated information about each of the groups execute the step of:

selecting, of all of the existing document information, the existing document information to be processed for classifying into the groups.

According to a sixth aspect of the invention, there is provided an information processing apparatus for creating a database having associated information about each of groups of existing document information, including:

classifying means for classifying the existing document information into the groups; and

single-out means for singling out at least one of the groups having the existing document information.

According to a seventh aspect of the invention, there is provided an information processing method for an information processing apparatus for creating a database having associated information about each of groups of existing document information, including the step of:

classifying the existing document information into the groups.

According to an eighth aspect of the invention, there is provided a recording medium storing a computer-readable program for creating a database having associated information about groups of existing document information, including the step of:

classifying the existing document information into the groups.

According to a ninth aspect of the invention, there is provided a program for having a computer for creating a database having associated information about each of the groups of existing document information execute the step of:

classifying the existing document information into the groups.

According to a tenth aspect of the invention, there is provided an information processing apparatus for classifying existing document information into groups and creating a database having associated information about each of the groups, including:

acquiring means for acquiring associated information about at least one of the groups having the existing document information.

According to an eleventh aspect of the invention, there is provided an information processing method for an information processing apparatus for classifying existing document information into groups and creating a database having associated information about each of the groups, including the step of:

acquiring associated information about at least one of the groups having the existing document information.

According to a twelfth aspect of the invention, there is provided a recording medium storing a computer-readable program for classifying existing document information into groups and creating a database having associated information about each of the groups, including the step of:

acquiring associated information about at least one of the groups having the existing document information.

According to a thirteenth aspect of the invention, there is provided a program for having a computer for classifying existing document information into groups and creating a database having associated information about each of the groups execute the step of:

acquiring associated information about at least one of the groups having the existing document information.

According to a fourteenth aspect of the invention, there is provided an information processing apparatus for classifying electronic mail sent or received in the past into groups and presenting associated information about each of the groups, the information processing apparatus including:

selecting means for determining, on the basis of the total number of the electronic mail sent or received in the past, a date/time condition and an address attribute condition of the electronic mail to be selected, and on the basis of the date/time condition and the address attribute condition, selecting the electronic mail sent or received in the past;

of the selected electronic mail, selecting means for classifying associated electronic mail into groups, determining a constituent mail count condition of the groups on the basis of-the total number of the groups, and singling out any of the groups on the basis of the constituent mail count condition;

deleting means for performing morphological analysis on the electronic mail belonging to the singled-out groups to create a word vector, and among the words constituting the word vector, deleting words belonging to many of the groups from the word vector as unnecessary words;

removing means for assigning an evaluation value to each of the words belonging to the word vector, and in the groups including the electronic mail of which date/time of transmission or reception is after a predetermined date/time, handling, as a recent word, each word having an evaluation value over a predetermined threshold included in the word vector, thereby removing any of the groups in which the evaluation value of the recent word occupies a higher position of the word vector; and

presenting means for searching for any of the groups that is similar to sent or received electronic mail and presenting associated information about the searched group.

According to a fifteenth aspect of the invention, there is provided an information processing apparatus for classifying electronic mail sent or received in the past into groups and presenting associated information about the groups, the information processing apparatus including:

on the basis of the total number of electronic mail sent or received in the past, determining means for determining a date/time condition and an address attribute condition of the electronic mail to be selected;

selecting means for selecting, on the basis of the date/time condition and the address attribute condition, the electronic mail sent or received in the past; and

classifying means for classifying the selected electronic mail the groups.

According to a sixteenth aspect of the invention, there is provided an information processing apparatus for classifying electronic mail sent or received in the past into groups and presenting associated information about the groups, the information processing apparatus including:

on the basis of the total number of the groups, determining means for determining a constituent mail count condition for the groups; and

on the basis of the constituent mail count condition, single-out means for singling out any of the groups.

According to a seventeenth aspect of the invention, there is provided an information processing apparatus for classifying electronic mail sent or received in the past into groups and presenting associated information about the groups, the information processing apparatus including:

creating means for creating a word vector from the electronic mail belonging to the groups;

deleting means for deleting, of the words constituting the word vector, words belonging to many of the groups as unnecessary words; and

on the basis of the word vector, search means for searching for the associated information about the groups.

According to an eighteenth aspect of the invention, there is provided an information processing apparatus for classifying electronic mail sent or received in the past into groups and presenting associated information about the groups, the information processing apparatus including:

creating means for creating a word vector from the electronic mail belonging to the groups;

assigning means for assigning an evaluation value to each of words included in the word vector; and

in the groups including the electronic mail of which date/time of transmission or reception is after a predetermined date/time, removing means for handling, as a recent word, each word having an evaluation value over a predetermined threshold included in the word vector, thereby removing any of the groups in which the evaluation value of the recent word occupies a higher position of the word vector.

With these configurations, words in which the user is interested are quickly extracted to present proper information to the user when electronic mail is not sent or received.

The above and other objects, features and advantages of the present invention will become apparent from the following description and the appended claims, taken in conjunction with the accompanying drawings in which like parts or elements denoted by like reference symbols.

### BRIEF DESCRIPTION OF THE DRAWINGS

These and other objects of the invention will be seen by reference to the description, taken in connection with the accompanying drawing, in which:

FIG. 1 is a schematic diagram illustrating an exemplary configuration of the functional blocks of an agent program practiced as one embodiment of the invention;

FIG. 2 is a block diagram illustrating an exemplary configuration of a personal computer on which the agent program of FIG. 1 is installed and executed;

FIG. 3 is a flowchart describing database creation processing by the agent program of FIG. 1;

FIG. 4 is a flowchart describing the process of step S5 shown in FIG. 3;

FIG. 5 is a flowchart describing the process of setting date/time condition and address attribute condition in step S22 of FIG. 4;

FIG. 6 is a diagram illustrating an exemplary topic file;

FIG. 7 is a diagram illustrating the elements included in a plurality of words which form a word vector;

FIG. 8 is a flowchart describing the primary topic single-out processing in step S3 of FIG. 3;

FIG. 9 is a flowchart describing the morphological analysis processing in step S4 of FIG. 3;

FIG. 10 is a diagram illustrating an exemplary configuration of a topic word table;

FIG. 11 is a diagram illustrating an exemplary configuration of a word index table;

FIG. 12 is a diagram illustrating an exemplary configuration of a topic evaluation value table;

FIG. 13 is a flowchart describing an unnecessary word deletion processing in step S5 of FIG. 3;

FIG. 14 is a flowchart describing a secondary topic single-out processing in step S9 of FIG. 3;

FIG. 15 is a flowchart describing a recommended topic determination processing in step S11 of FIG. 3;

FIG. 16 a flowchart describing a Web search processing in step S12 of FIG. 3;

FIG. 17 is a flowchart describing an associated-information presentation processing of the agent program of FIG. 1;

FIG. 18 is a diagram illustrating an exemplary time-dependent transition of the evaluation values of the words accumulated in the database;

FIG. 19 is a flowchart describing agent's actions or the like;

FIG. 20 is a flowchart describing the details of the standby processing in step S151 of FIG. 19;

FIG. 21 is a diagram illustrating an exemplary display of the agent on desktop;

FIG. 22A through FIG. 22D are diagrams illustrating exemplary displays which is shown when the agent appears;

FIG. 23 is a diagram illustrating an exemplary display of a balloon indicative of agent's speech;

FIG. 24 is a diagram illustrating an exemplary display which is shown when the agent is in a standby state;

FIG. 25 is a diagram illustrating an exemplary display which is shown when the agent is working;

FIG. 26 is a diagram illustrating an exemplary display of an input window shown on desktop;

FIG. 27 is a diagram illustrating another exemplary display of the input window;

FIG. 28 is a diagram illustrating an exemplary display of a recommended URL shown on desktop;

FIG. 29 is a diagram illustrating an exemplary display which is shown when the agent is pointing at the associated information editing window;

FIG. 30 is a diagram illustrating an exemplary display of a scrap book window shown on desktop;

FIG. 31A and FIG. 31B are diagrams illustrating exemplary displays which are shown when the agent is in delight;

FIG. 32A and FIG. 32B are diagrams illustrating exemplary displays which are shown when the agent is in sorrow;

FIG. 33A through FIG. 33D are diagrams illustrating exemplary displays which are shown when the agent is moving horizontally;

FIG. 34A through FIG. 34G are diagrams illustrating exemplary displays which are shown when the agent is moving vertically;

FIG. 35A and FIG. 35B are diagrams illustrating exemplary displays which are shown when the agent is in play;

FIG. 36 is a diagram illustrating an exemplary display which is shown when the agent is in sleep;

FIG. 37A and FIG. 37B are diagrams illustrating exemplary display which is shown when the agent is leaving;

FIG. 38 is a diagram illustrating an exemplary display of a menu box;

FIG. 39 is a diagram illustrating an exemplary display of a setting screen;

FIG. 40 is a flowchart describing the database update processing by the agent program of FIG. 1; and

FIG. 41 is a diagram illustrating an exemplary configuration of a user interface for entering database update conditions.

### DETAILED DESCRIPTION OF PREFERRED EMBODIMENTS

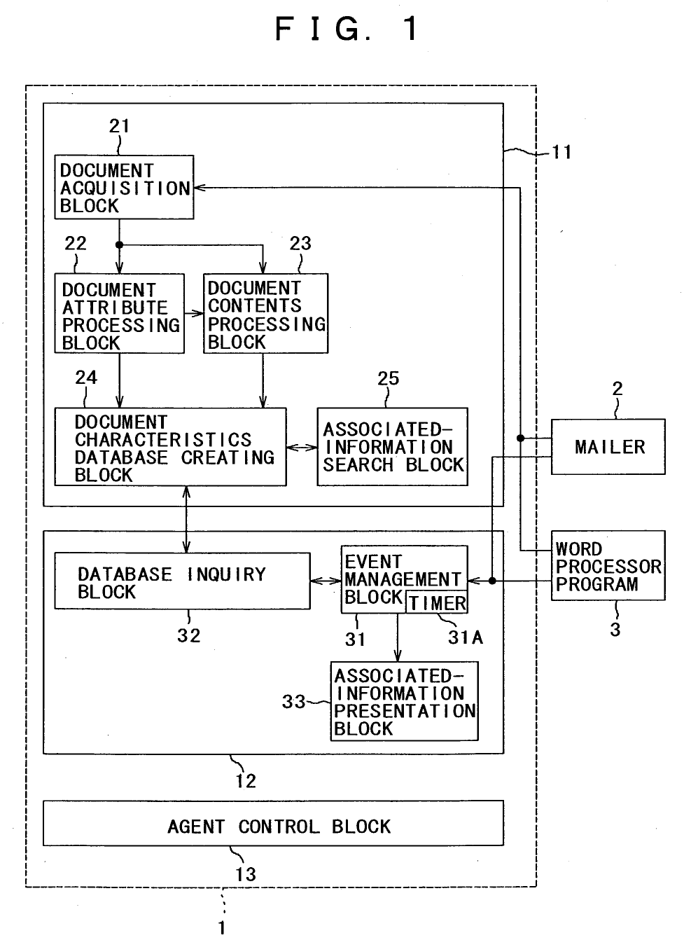

This invention will be described in further detail by way of example with reference to the accompanying drawings. Now, referring to FIG. 1, there is shown a relationship between an application program 1 (hereafter referred to as an agent program) for displaying a desktop mascot (hereafter referred to as an agent), an application program 2 (hereafter referred to as a mailer) for sending and receiving electronic mail, and a word processor program 3 for creating or editing documents to which the present invention is applied.

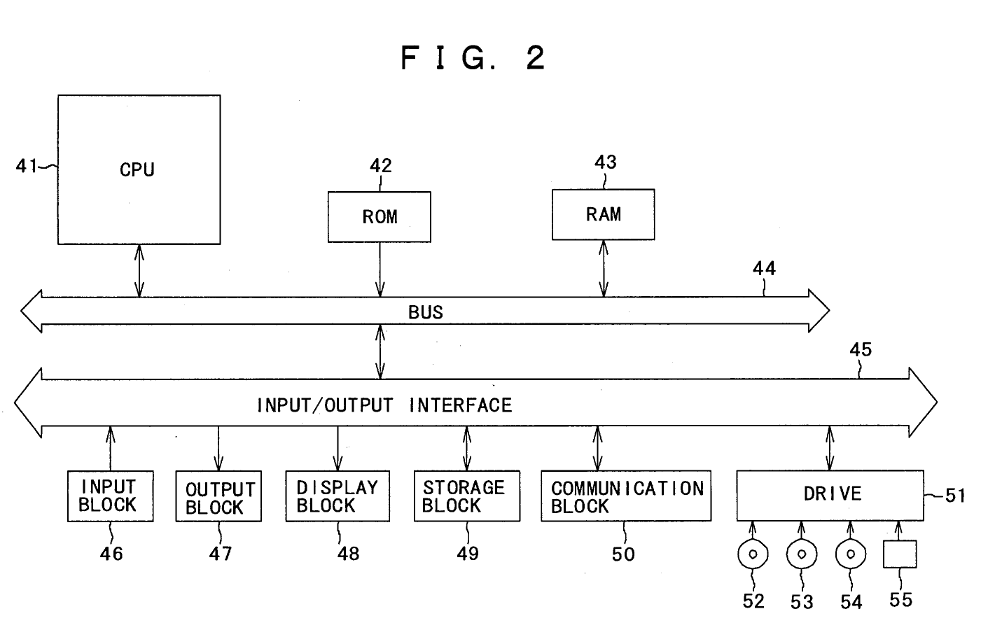

The agent program 1 through the word processor program 3 are installed on a personal computer (of which details will be described later with reference to FIG. 2) and executed thereon.

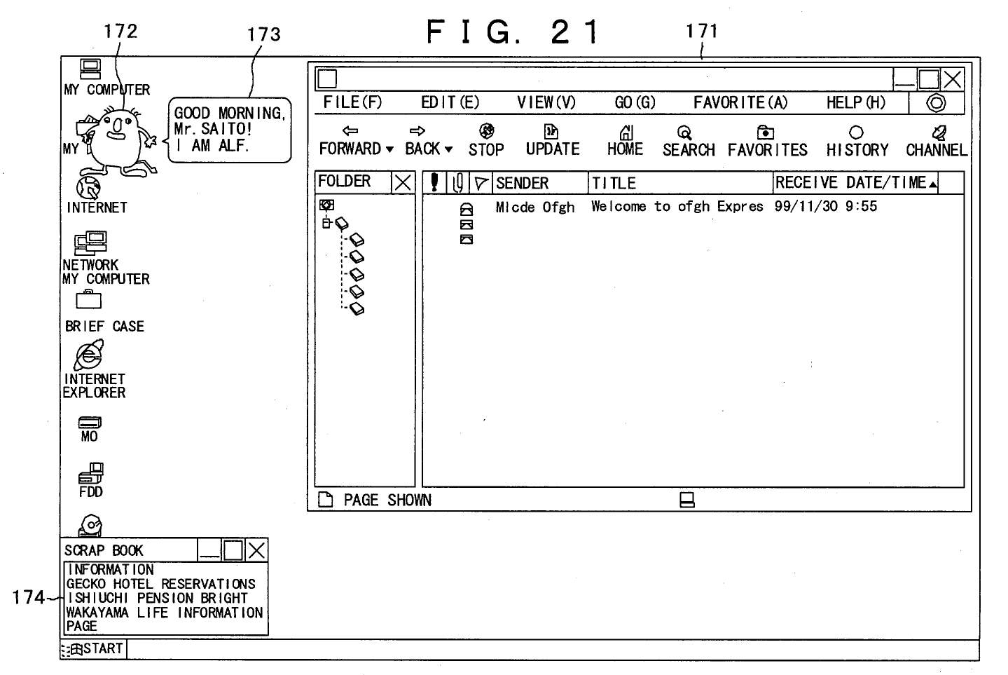

The agent program 1 is configured by an accumulation block 11 for accumulating the associated-information (to be described later) about each document to be processed to construct a database, a presentation block 12 for presenting the associated information about each document to be processed to the user, and an agent control block 13 for controlling the displaying or the like of an agent 172 (FIG. 21).

It should be noted that the accumulation block 11 and the presentation block 12 may be installed on an arbitrary server in the internet for example.

A document acquisition block 21 of the accumulation block 11 acquires the documents not yet processed by the document acquisition block 21 from among the documents sent or received by the mailer 2 or the documents edited by the word processor program 3 and supplies the acquired document to a document attribute processing block 22 and a document contents processing block 23.

In what follows, an example in which electronic mail documents sent and received by the mailer 2 are processed is mainly explained.

The document attribute processing block 22 extracts the attribute information of documents supplied from the document acquisition block 21, puts the supplied documents into groups on the basis of the extracted attribute information, and supplies the grouped documents to the document contents processing block 23 and a document characteristics database creating block 24. In the case of electronic mail, the information described in the header of each document (message ID for identifying an electronic mail message subject to processing, message ID (References, In-Reply-To), address (To, Cc, Bcc), or send source (From), date and time (Date/time), and subject (Subject) of an electronic mail message being referenced. On the basis of the extracted attribute information, one or more documents are grouped. In what follows, the document groups (electronic mail groups) formed on the basis of the attribute information are referred to as a “topic.”

Generally, the term topic as used herein denotes a series of document groups associated with each other in a certain relationship for all documents of not only electronic mail but also formed by word processors, editors, schedulers and other tools and application software.

The document contents processing block 23 extracts the body of a document group (a topic) formed by the document attribute processing block 22 and performs morphological analysis on the extracted body to acquire words (or characteristic words). Words are classified into groups of word parts (noun, adjective, verb, adverb, conjunction, exclamation, propositional particle, and auxiliary verb) However, the word parts other than nouns including such words distributed over most documents as “hello,” “regards,” and “please” for example cannot be used as keywords (hereafter also referred to as search words), they are deleted as unnecessary words from the keywords.

Also, the document contents processing block 23 obtains the occurrence frequency of each of the words after the deletion of unnecessary words and the distributed state of each word after the deletion over a plurality of documents and computes the weight of each word (a value indicative of the degree associated with the gist of document, hereafter referred to as an evaluation value) for each of the document groups (topics).

In addition, for each topic, the document contents processing block 23 determines a characteristic vector with the evaluation value of word used as an element. For example, if the total number of words (characteristic words) contained in each topic is n for example, then the characteristic vector of each topic is expressed in equation (1) below as n-dimensional space vector:

Characteristic vector=(evaluation value w1 of word 1, evaluation value w2 of word 2, . . . evaluation value wn of word n) (1)

For the computation of evaluation values, the tf·idf method disclosed in a document (Salton, G.: Automatic Text Processing: The Transformation Analysis and Retrieval of Information by Computer, Addison-Wesley, 1989) for example. According to the tf·idf method, among the n-dimensional characteristic vectors for topic A, a value other than 0 is computed as the evaluation value for the element corresponding to each word included in topic A, and 0 is computed as the evaluation value for the element corresponding to each word (of which occurrence frequency is 0) not included in topic A.

It should be noted that the evaluation value is corrected in accordance with the frequency and count in the communication of electronic mail, the type of part of each word included in electronic mail (proper nouns indicative of particular regions and names), and the communication partner for example.

In the present embodiment, the characteristic vector is computed for each topic. It will be apparent that the characteristic vector may also be computed for each document or any other unit (for example, for each document group accumulated in a predetermined period, for example one week.

The document characteristics database creating block 24 forms the attribute information about each document of each document group (topic) formed by the document attribute processing block 22 and the characteristic vector (namely, the evaluation value of each word included in the topic) of each topic computed by the document contents processing block 23 into a database in a time-dependent manner and records this database to a storage block 49 (FIG. 2) constituted by a hard disk drive for example. Also, the document characteristics database creating block 24 selects the words which satisfy predetermined conditions by referencing the word evaluation values and records the selected words as the search key words (or search words) for searching the associated information. Moreover, the document characteristics database creating block 24 supplies the search words to an associated information search block 25 and records the associated information from the associated-information search block 25 by relating the supplied information with the search words.

The associated-information search block 25 searches the associated information for the search words supplied from the document characteristics database creating block 24 and supplies the obtained index to the document characteristics database creating block 24. For a method of searching the associated information about search words, a search engine in the internet may be used, for example. If a search engine in the internet is used, the URL (Uniform Resource Locator) of a Web page retrieved as a result of the search and the title of that Web page are supplied to the document characteristics database creating block 24 as the associated information.

When an event management block 31 of the presentation block 12 detects the activation of the mailer 2, the completion of an electronic mail send/receive operation mail by the mailer 2, and the exceeding of a predetermined threshold of the text data amount in a document being entered, the event management block 31 notifies these events to a database inquiry block 32 thereof. In what follows, the completion of an electronic mail send/receive operation or the exceeding of a predetermined threshold of the text data amount of a document being entered is referred to as the occurrence of an event.

The event management block 31 monitors the passing of time by referencing an incorporated timer 31A, and when a predetermined time has passed from a predetermined timing, the event management block 31 notifies the event to the database inquiry block 32 thereof.

In response to the notification of an event occurrence from the event management block 31, the database inquiry block 32 acquires a document corresponding to the event occurrence (for example, received electronic mail), performs morphological analysis on the document to extract words in the same manner as the processing of the document contents processing block 23, and computes the evaluation value of each of the words after removing the unnecessary words. Thus, the characteristic vector of the document corresponding to an event occurrence is computed.

In addition, the database inquiry block 32 searches the database created by the document characteristics database creating block 24 and computes the inner product between the computed characteristic vector of the document corresponding to an event occurrence and the characteristic vector of each of the topics recorded to the database as the similarity between the vectors. Further, the database inquiry block 32 determines the topic having the highest similarity to the document corresponding to the event occurrence, and from the words included in this topic, selects a word of which evaluation value satisfies predetermined conditions (of which details will be described later), and supplies the associated information about the selected word (an important word) to an associated-information presentation block 33 via the event management block 31 or directly.

The associated-information presentation block 33 displays the associated information supplied from the database inquiry block 32 onto a display block 48 (desktop) via the event management block 31 or directly. Namely, every time the event management block 31 detects the occurrence of an event, the presentation of the associated information by the presentation block 12 is updated.

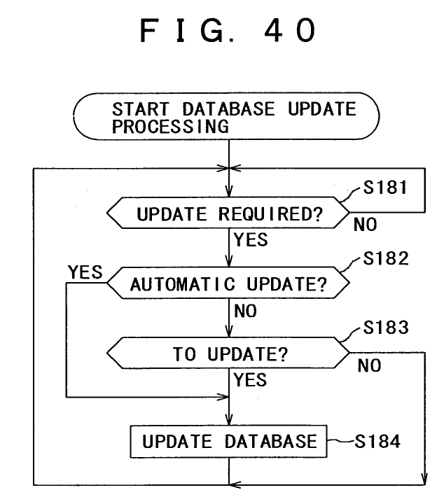

It should be noted that the database updating operation by the accumulation block 11 is executed in a predetermined timed relation. The data base update processing will be described later with reference to the flowchart shown in FIG. 40. At the updating of the database by the accumulation block 11, the characteristic vectors recorded in the storage block 49 are corrected in accordance with the frequency and count of electronic mail send/receive operations and the types of word parts (proper nouns indicative of particular regions and names) for-example.

Referring to FIG. 2, there is shown an exemplary configuration of a personal computer in which the agent program 1, the mailer 2 and the word processor program 3 are installed and executed. It will be apparent that the present invention is applicable to not only personal computers but also television receivers, home server systems, hard disk recorders, game machines, automobile navigation systems, mobile telephones, PDAs, and other information electronic equipment.

This personal computer incorporates a CPU (Central Processing Unit) 41. The CPU 41 is connected to an input/output interface 45 via a bus 44. The input/output interface 45 is connected to an input block 46 composed of input devices such as keyboard and mouse, an output block 47 which outputs an audio signal for example as a result of processing, the display block 48 constituted by a display device for displaying an image as a result of processing, the storage block 49 constituted by a hard disk drive for storing programs and constructed databases, a communication block 50 constituted by a LAN (Local Area Network) card for communicating data over a network such as typified by the Internet, and a drive 51 which reads and writes data on from and to a recording medium such as a magnetic disk 52, an optical disk 53, a magneto-optical disk 54, or a semiconductor memory 55. The bus 44 is connected to a ROM (Read Only Memory) 42 and a RAM (Random Access Memory) 43.

The agent program 1 according to the invention is supplied to the personal computer in one of the recording media, a magnetic disk 52, an optical disk 53, a magneto-optical disk 54, or a semiconductor memory 55, read by the drive 51 or retrieved via the network by the communication block 50, and installed in the hard disk drive incorporated in the storage block 49. The agent program 1 installed in the storage block 49 is loaded from the storage block 49 into the RAM 43 and executed in accordance with a command of the CPU 41 entered by the user through the input block 46. It should be noted that the agent program 1 may also be set to be automatically executed at the startup of the personal computer.

In addition to the agent program 1, the mailer 2, the word processor program 3 and application programs such as a WWW (World Wide Web) browser are installed in the hard disk drive incorporated in the storage block 49. As with the agent program 1, these programs are loaded from the storage block 49 to the RAM 43 and executed in accordance with a command by the CPU 41 entered by the user through the input block 46.

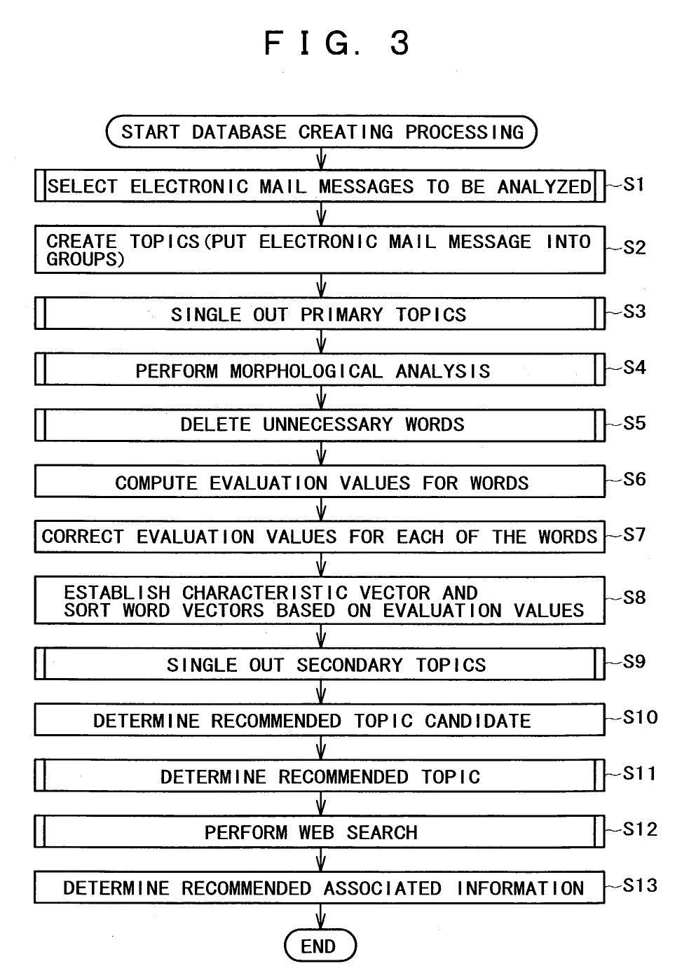

The following describes the database creation processing to be executed by the agent program 1 with reference to the flowchart shown in FIG. 3. This database creation processing is one of the processing operations to be executed by the agent program 1. This processing is started when no database has been created in the state in which the agent program 1 has been started up.

In step S1, the document acquisition block 21, from hard disk drive incorporated in the storage block 49, selectively acquires a document (for example, the electronic mail sent or received before the agent program 1 is executed, which is hereafter referred to as subject-to-analysis electronic mail) subject to analysis as a source of database creation and supplies the subject-to-analysis electronic mail to the document attribute processing block 22 and the document contents processing block 23.

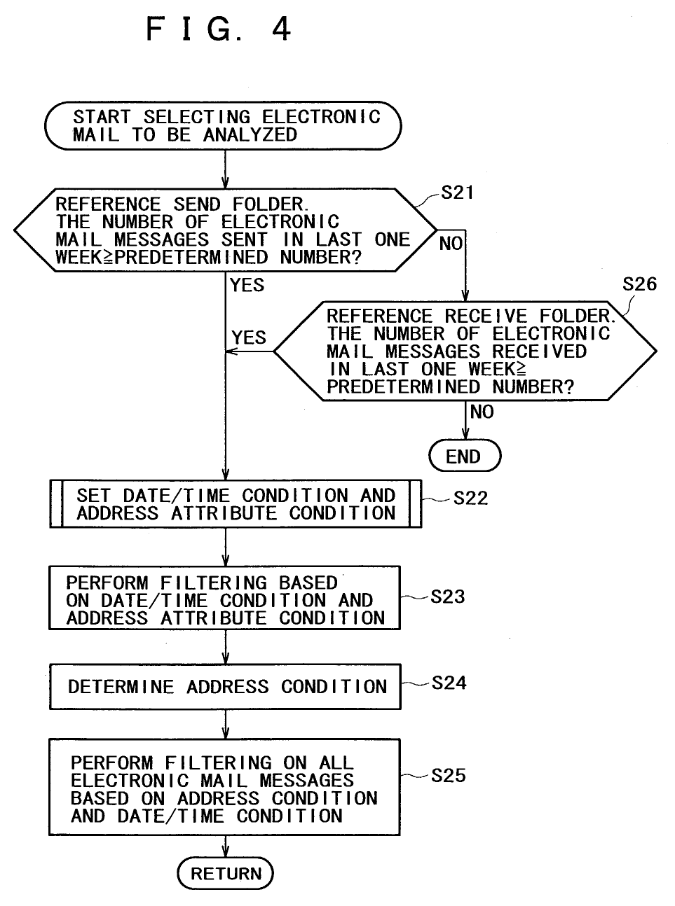

The following describes the details of the process of step S1, namely the details of the subject-to-analysis electronic mail selection processing, with reference to FIG. 4.

In step S21, the document acquisition block 21 references the send folder in which the electronic mail sent by the user is stored and determines whether the number of electronic mail messages sent in a predetermined most recent period (for example, the last one week) is equal to or higher than a predetermined value (for example, 100). If the number of electronic mail messages sent in a predetermined most recent period is found equal to or higher than a predetermined value, then the procedure goes to step S22. In step S22, the document acquisition block 21 sets a date/time condition and an address attribute condition.

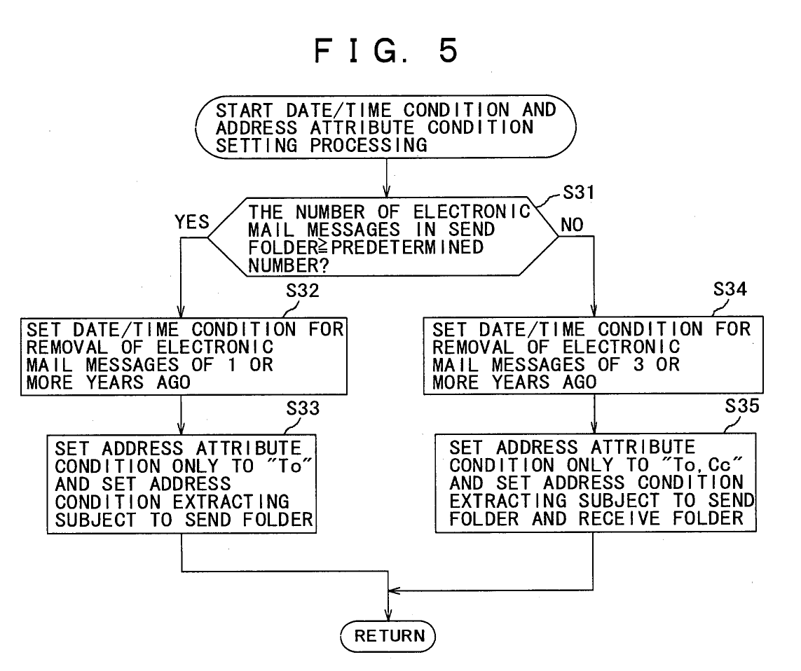

The following describes the details of the process in step S22, namely the details of setting a date/time condition and an address attribute condition, with reference to FIG. 5. In step S31, the document acquisition block 21 determines whether the number of electronic mail messages in the send folder is equal to or higher than a predetermined value (for example, 100).

If the number of electronic mail messages in the send folder is found equal to or higher than a predetermined value in step S31, then the procedure goes to step S32. In step S32, the document acquisition block 21 sets the date/time condition for selecting the subject-to-analysis electronic mail to “delete mail one or more years ago.” In step S33, the document acquisition block 21 sets the address attribute condition for selecting subject-to-analysis electronic mail to “delete other than To.” Also, the document acquisition block 21 sets the address attribute condition (an address list) extraction subject to the send folder.

On the other hand, if the number of electronic mail messages in the send folder is found not equal to or higher than a predetermined value in step S31, the procedure goes to step S34. In step S34, the document acquisition block 21 sets the date/time condition to “delete mail 3 or more years ago.” In step S35, the document acquisition block 21 sets the address attribute condition to “delete other than To, Cc.” Also, the document acquisition block 21 sets the address attribute condition extraction subject to the send folder and the receive folder.

The procedure returns to S23 shown in FIG. 4 after setting the date/time condition and address attribute condition for the subject-to-analysis electronic mail in correspondence with the number of sent electronic mail messages by the above-mentioned date/time condition and address attribute condition setting processing.

It should be noted that, in the date/time condition and address attribute condition setting processing, not only the above-mentioned two types of selections but also other selections may be made such that the date/time condition is divided by the given number of years by partitioning the send folder in accordance with the number of mail messages in the send folder or “From,” “Reply to,” or the like are be added to the address attribute condition for the received mail list.

In step S23, the document acquisition block 21 filters the electronic mail in the sent folder (or the receive folder) on the basis of the date/time and address attribute condition set in step S22 to narrow down the number of electronic mail messages. In step S24, the document acquisition block 21 lists the addresses (or the sources of transmission) of the electronic mail messages filtered in step S23, counts the occurrence frequencies of these addresses, determines the higher n addresses of higher occurrence frequencies, and sets the address condition to “extract electronic mail sent/received from the higher n addresses.”

In step S25, the document acquisition block 21 selects the subject-to-analysis electronic mail by filtering all electronic mail messages, namely the electronic mail messages in the send folder, the receive folder, and other folders, on the basis of the date/time condition set in step S22 and the address condition set in step S24.

It should be noted that, if the folder in which the electronic mail messages sent by the user are stored is referenced and the number of electronic mail messages sent in the predetermined most recent period is found lower than a predetermined value, then the procedure goes to step S26. In step S26, the document acquisition block 21 references the receive folder in which the electronic mail messages sent by the user to determine whether the number of electronic mail messages received in a predetermined most recent period (for example, the last one week) is equal to or higher than a predetermined value (for example, 100). If the number of electronic mail messages received in the predetermined most recent period is found equal to or higher than the predetermined value, then the procedure goes to step S22 to repeat the above-mentioned processes.

On the other hand, if the number of electronic mail messages received in the predetermined most recent period is found lower than the predetermined value, then the database creation processing comes to an end.

As described above, if the subject-to-analysis electronic mail has been selected, the procedure returns to step S2 shown in FIG. 3.

In step S2, the document attribute processing block 22 extracts the attribute information (the header information such as message ID) from the subject-to-analysis electronic mail supplied from the document acquisition block 21 in step S1, classifies the subject-to-analysis electronic mail messages into topics (namely, groups the messages into topics) on the basis of the extracted attribute information, creates a topic file for each of the topics, and supplies the created topic files to the document contents processing block 23 and the document characteristics database creating block 24.

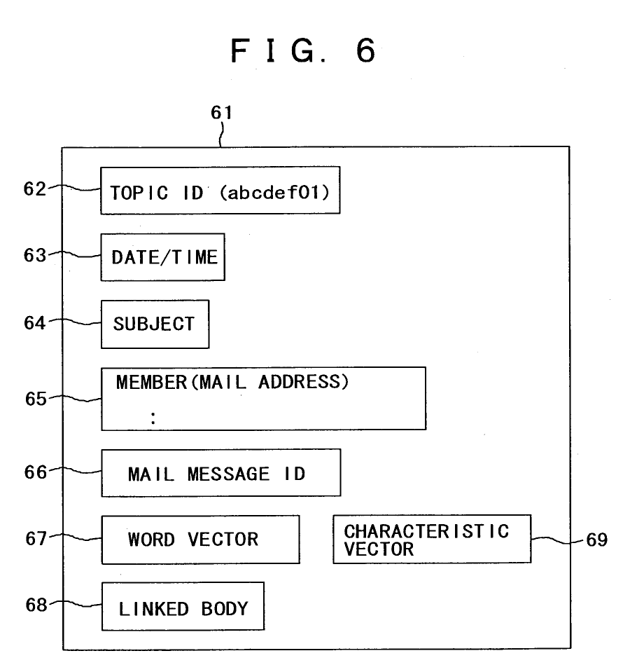

Referring to FIG. 6, there is shown one example of a topic file 61 which is created in step S2. The topic file 61 is composed of topic ID 62 for identifying each topic file, date/time information 63 indicative of the communication time of the oldest electronic mail message belonging to that topic, subject information 64 indicative of the title or the like of this oldest electronic mail message, member information 65 consisting electronic mail addresses of senders or receivers of electronic mail messages belonging to that topic, mail message ID 66 for identifying each electronic mail message belonging to that topic, word vector 67 consisting of the words included in the body of each electronic mail message belonging to that topic, linked body 68 linked with the body of each electronic mail message belonging to that topic, and characteristic vector 69 consisting of the evaluation values of all words included in any topic.

For topic ID 62, the communication time of the oldest electronic mail message belonging to that topic for example.

It should be noted that, for linked body 68, a predetermined character string (for example, “soshin-shuryo”) is inserted after performing body linkage for the electronic mail messages stored in the send folder of the electronic mail messages belonging to that topic and body of each electronic mail message stored in the receive folder or other folders is linked.

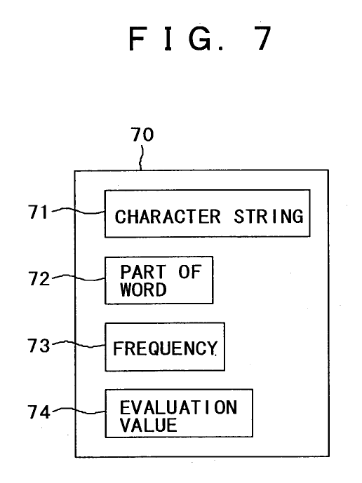

Referring to FIG. 7, there is shown the elements included in a plurality of words 70 which form word vector 67. To be more specific, word 70 has a configuration for recording character string 71 of that word itself, word part (type of noun) 72, frequency 73 of that word in that topic, and evaluation value 74 of that word in that topic. It should be noted that the contents of each of the elements in word 70 are not generated at the processing stage of step S2; they are generated in the subsequent processing.

Characteristic vector 69 is not generated at the processing stage of step S2 either; it is generated in the subsequent processing.

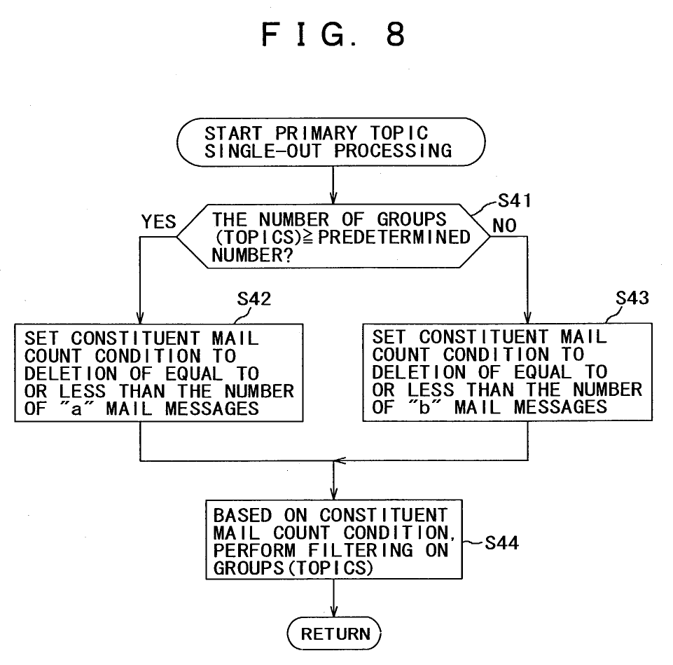

Now, with reference to FIG. 3 again, in step S3, the document attribute processing block 22 singles out a topic generated in step S2. The following describes the process of step S3, namely primary topic single-out processing with reference to the flowchart shown in FIG. 8.

In step S41, the document attribute processing block 22 determines whether the number of topics generated in step S2 is equal to or higher than a predetermined value. If the number of generated topics is found equal to or higher than a predetermined value, then the procedure goes to step S42. In step S42, the document attribute processing block 22 sets the constituent mail count condition for singling out generated topics to “delete equal to or less than a (for example, 4) messages.”

On the other hand, if the number of generated topics is found lower than a predetermined value, then the procedure goes to step S43. In step S43, the document attribute processing block 22 sets the constituent mail count condition for singling out generated topics to “delete equal to or less than b (for example, 2) messages.”

In step S44, on the basis of the constituent mail count condition set above, the document attribute processing block 22 filters the topics generated in step S2. To be more specific, if the constituent mail count condition has been set to “delete equal to or less than a (for example, 4) messages” above for example, any topic consisting of equal to or less than 4 electronic mail messages is deleted and the topics each consisting of 5 or more electronic mail messages are singled out.

Further, those topics which do not include the electronic mail messages communicated in a predetermined most recent period (for example, the last one week) may be deleted.

After the primary topic single-out processing has been thus executed, the procedure returns to step S4 shown in FIG. 3.

It should be noted that, for the constituent mail count condition in the primary topic single-out processing, other selections than the above-mentioned two selections may be set; for example, several sections in accordance with the number of topics may be arranged and the constituent mail count condition may be determined for each of these sections.

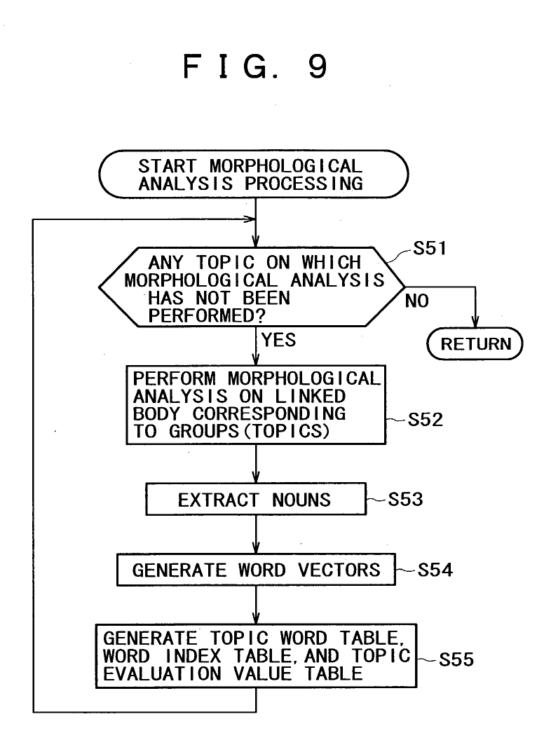

In step S4, the document contents processing block 23 executes morphological analysis on the linked body 68 of the topic file 61 corresponding to each of the singled out topics. The following describes the details of-the morphological analysis processing in step S4 with reference to the flowchart shown in FIG. 9.

In step S51, the document contents processing block 23 determines whether there is any topics among the singled out topics that has not been morphological-analyzed. If such topics are found, the procedure goes to step S52. In step S52, the document contents processing block 23 selects one of the topics, reads out the linked body 68 of the corresponding topic file 61, performs morphological analysis on the selected topic, and extracts words included in the linked body 68.

Thus, in the processing of performing morphological analysis on the linked body 68 of the topic file 61, the sentence to be processed is longer than that of the processing in which morphological analysis is performed on each body of each electronic mail message constituting the topic file 61. However, in the former processing, the processing may only performed once, thereby preventing the resources necessary for the processing from being wasted.

In step S53, the document contents processing block 23 extracts the words extracted in step S52 of which word part is noun (including general noun, connective name, geographical name, personal name, and term of interest). In step S54, the document contents processing block 23 aligns the extracted noun words to generate a word vector 67 which corresponds to the topic concerned.

In step S55, the document contents processing block 23 adds a record of the word vector 67 generated in step S54 to a topic word table 81 (FIG. 10) and adds a record of the words constituting the word vector 67 generated in step S54 to a word index table 91 (FIG. 11) which includes a topic evaluation value table 93. It should be noted that the topic word table 81, the word index table 91, and topic evaluation value table 93 are hash tables.

Referring to FIG. 10, there is shown an exemplary configuration of the topic word table 81. The topic word table 81 lists topic IDs 62 for topics and corresponding word vectors 67. Each word vector 67 is outputted by specifying its corresponding topic ID 62.

Referring to FIG. 11, there is shown an exemplary configuration of the word index table 91. The word index table 91 lists a plurality of pairs of word names 92 constituting each word vector 67 and the corresponding topic evaluation value table 93. Each topic evaluation value table 93 is outputted by specifying its word name 92.

Referring to FIG. 12, there is shown an exemplary configuration of the topic evaluation value table 93. The topic evaluation value table 93 lists the topic IDs 101 of topics in which the words corresponding to word names 92 are included and the evaluation values 102 of the words in the topic concerned. The evaluation value 102 of a particular word in the topic concerned is outputted by specifying the topic ID 101.

Generating the topic word table 81, the word index table 91, and the topic evaluation value table 93 having the above-mentioned configuration allows easy search for the topic ID 62 or the word name 92 by specifying the other.

Then, the procedure returns to step S51 to repeat the above-mentioned processes. Next, in step S51, if there is no singled-out topics that have not been morphological-analyzed, the morphological analysis comes to the end and the procedure returns to step S5 shown in FIG. 3.

In step S5, in order to mitigate the subsequent processing, the document contents processing block 23 deletes those words which are considered less related to the contents of the topic and the words of routine greetings for example (these words are hereafter referred to as unnecessary words) from the words extracted, that is the words included in the word vector of each topic.

The following describes the unnecessary word deletion processing in step S5 with reference to the flowchart shown in FIG. 13. In step S61, the document contents processing block 23 deletes a topic having a small word vector, namely a topic in which the number of words constituting the corresponding word vector is equal to or lower than a predetermined value (for example, 5).

In step S62, the document contents processing block 23 determines whether there are any words that are not subject to the subsequent processing among the words recorded to the word index table 91 created in the process of step S4. If such words are found, the procedure goes to step S63. In step S63, the document contents processing block 23 selects, as the word to be processed, one of the words not subject to the processing recorded in the word index table 91.

In step S64, the document contents processing block 23 references the word index table 91 by entering the word to be processed to acquire the corresponding topic evaluation value table 93 and counts the number of topic IDs 101 recorded to the retrieved topic evaluation value table 93, thereby acquiring the topic which include the word to be processed.

In step S65, the document contents processing block 23 determines whether the number of topics which includes the word to be processed is equal to or higher than a predetermined value. If the number of topics which include the word to be processed is found equal to or higher than a predetermined value, then the procedure goes to step S66. In step S66, the document contents processing block 23 adds the word to be processed to the unnecessary word vector (consisting of unnecessary words) Consequently, the routine words such as greetings which are considered included commonly in many topics are added to the unnecessary word vector.

In step S67, in order to delete the record corresponding to the unnecessary words to be processed, the document contents processing block 23 updates the topic file 61, the topic word table 81, the word index table 91, and the topic evaluation value table 93 which correspond to each topic. Then, the procedure returns to step S62 to repeat the above-mentioned processing.

It should be noted that, if the number of topics including the word to be processed is found lower than a predetermined value, the procedure also returns to step S62 by skipping steps S66 and S67.

Next, in step S62, if no word is found subject to subsequent processing among the words recorded to the word index table 91 generated in step S4, then the procedure goes to step S68. In step S68, the document contents processing block 23 deletes the topics having a small word vector, namely the topics in which the number of words constituting the corresponding word vector 67 is equal to or lower than a predetermined value (for example, 5), in the same manner as the process of step S61. Consequently, the topics which are regarded consisting only routine words are deleted. At this point of processing, each topic is symbolized by the word vector 67 which consists of characteristic words. Then, the procedure returns to step S6 shown in FIG. 3.

In step S6, the document contents processing block 23 obtains the occurrence frequency and the distribution over a plurality of documents of all words constituting each word vector 67 with the unnecessary words deleted, to compute the evaluation value for each topic. For this computation, the tf·idf method for example is used. In step S7, the document characteristics database creating block 24 corrects the evaluation value for each word obtained in step S6 in accordance with the following conditions.

For example, this correction is made so that the evaluation value of the words included in a sent electronic mail message becomes higher. To identify the words included in each sent electronic mail message, the predetermined character string (for example, “soshin-shuryo”) inserted in the linked body 68 of the topic file 61 corresponding to each topic generated in step S2 may be detected to identify the words preceding this predetermined character string as the words included in the sent electronic mail message.

This correction is also made so that the evaluation value of the words included in a topic which belongs to many electronic mail messages becomes greater in proportion to the number of these electronic mail messages. For example, let the number of electronic mail messages to which such a topic belongs be m, then the evaluation value before correction is multiplied by monotonously increasing function values such as linear function value a·m (a is a constant) and logarithmic function value log(m). Because this correction is made by considering the inclination in which many words that appeared preceding documents are substituted by demonstrative pronouns in subsequent documents in the temporally continuing communication like electronic mail, as the number of electronic mail messages belonging to a particular topic increases, the evaluation value of each word is made relatively lower.

Further, this correction is made so that the evaluation values of the words included in electronic mail communicated with a partner become high in communication frequency and the evaluation values of particular nouns (for example, defined words of interest, general names, geographical names, and organization names) become greater. It should be noted that the invention disclosed in Japanese Patent Application No. 2001-379511 may be applied to the method of correcting the evaluation values for particular nouns.

In step S8, the document characteristics database creating block 24 records the evaluation value for each word computed in step S6 and corrected in step S7 to the topic file 61, the word vector 67 in the topic word table 81, and the topic evaluation value table 93 in the word index table 91. Consequently, all elements of the words 70 constituting each word vector 67 have been determined. In addition, the document characteristics database creating block 24 determines the characteristic vector 69 corresponding to each topic and records the determined characteristic vector 69. Further, the document characteristics database creating block 24 sorts the constituent words in the descending order of their evaluation values for each word vector 67.

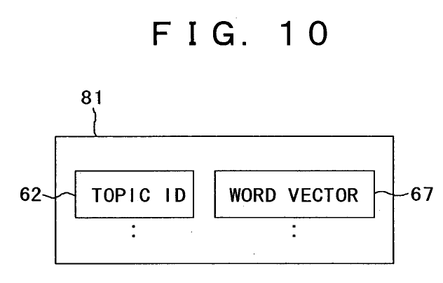

In step S9, the document characteristics database creating block 24 singles out any topics that still remain unselected at this point of processing. The process of step S9, namely secondary topic single-out processing will be described with reference to the flowchart shown in FIG. 14. It should be noted that this secondary topic single-out processing is executed for each remaining topic.

In step S71, the document characteristics database creating block 24 detects the word having the highest evaluation value (or top 2 or 3 words) among the words constituting the word vector 67 corresponding to the word singled out above. In step S72, the document characteristics database creating block 24 determines whether the evaluation value of the word detected in step S71 is equal to or higher than a predetermined value. If the evaluation value of the detected word is found equal to or higher than a predetermined value, the procedure goes to step S73.

In step S73, the document characteristics database creating block 24 determines whether the most recent communication date/time of the electronic mail belonging to the topic concerned is before a predetermined most recent period (for example, the last one week). If this communication date/time is found not before the predetermined most recent period, the procedure goes to step S74. In step S74, the document characteristics database creating block 24 adds the word having the highest evaluation value in the topic concerned to the most recent period. In step S75, the document characteristics database creating block 24 deletes the topic concerned. Because the topics that are too recent are deleted in steps S73 through S75, the element of surprise may be enhanced in the recommendation of the associated information, which will be described later.

It should be noted that, if the evaluation value of the word detected in step S71 is found lower than a predetermined value in step S72, then the procedure goes to step S75 by skipping steps S73 and S74.

If the most recent communication date/time of the electronic mail belonging to the topic concerned is found before the predetermined most recent period in step S73, then the secondary topic single-out processing for the topic concerned comes to an end, upon which the secondary topic single-out processing for a next topic starts.

When the secondary topic single-out processing has been performed on all topics, those singled out topics in which the words included in the most recent word vector are included in the top of the corresponding word vectors 73 (namely, top 2 or 3 having high evaluation values) are deleted. Consequently, the element of surprise in the recommendation of the associated information to be described later may be enhanced. Then, the procedure returns to step S10 shown in FIG. 3.

In step S10, by paying attention to the maximum value of the evaluation values of the constituent words, the document characteristics database creating block 24 detects the word vectors 67 by a predetermined number (for example, 200) in the descending order of the evaluation values for each of the word vectors 67 corresponding to the topics singled out at this point of processing, and specifies the predetermined number of corresponding topics as recommended topic candidates.

In step S11, on the basis of the recommended topic candidates determined in step S10, the document characteristics database creating block 24 determines the recommended topics. The following describes the recommended topic determination processing in step S11 with reference to the flowchart shown in FIG. 15.

In step S81, the document acquisition block 21 acquires the electronic mail messages, which satisfy the address attribute condition, communicated in a predetermined recent period (for example, the last one week) from the send folder and receive folder of the mailer 2. It should be noted that each of electronic mail messages acquired here has already been classified into one of the topics.

In step S82, by referencing the mail message IDs 66 of the all generated topic files 61, the document attribute processing block 22 identifies the topic to which each of the electronic mail messages acquired in step S81 belongs.

In step S83, the document characteristics database creating block 24 acquires the characteristic vector 69 (hereafter referred to as characteristic vector Vc) corresponding to each of the recent topics identified in step S82. In step S84, in order to determine the similarity between each characteristic vector Vc and the characteristic vector 69 (hereafter referred to as characteristic vector Vt) corresponding to each of the recommended topic candidates determined in step S10, the document characteristics database creating block 24 computes the inner product Sim(Vc, Vt) between all combinations of characteristic vector Vc and characteristic vector Vt as follows:

Sim(Vc, Vt)=Vc·Vt/|Vt|∝Vc·Vt/(|Vt|·|Vc|)

In the above-mentioned equation, the inner product Sim(Vc, Vt) is used only for determining the similarity of characteristic vector Vt to each characteristic vector Vc, so that the computation of division by the absolute value |Vc| of characteristic vector Vc may be omitted.

In step S85, the document characteristics database creating block 24 determines the characteristic vector Vt in which the result of inner product computation is the highest for each of characteristic vectors Vc and determines a recommended topic candidate corresponding to the determined characteristic vector as a recommended topic. At this point of processing, the number of topics to which the mail messages satisfying the address attribute condition among the most recent electronic mail messages and the same number of recommended topics are determined.

In step S86, the document characteristics database creating block 24 determines whether the number of recommended topics determined in step S85 is lower than a predetermined number (for example, 30). If the number of determined recommended topics is found lower than the predetermined number, the processing goes to step S87. In step S87, the document characteristics database creating block 24 adds, to the recommended topics, the topic candidates to fill the shortage up to the predetermined number of recommended topics determined in step S85, by selecting the topics having the highest evaluation values of included words from among the recommended topic candidates which have not been determined as recommended topics at this point of processing.

It should be note that, if the number of recommended topics determined in step S85 is found equal to or higher than the predetermined value, then the process of step S87 is skipped.

When the number of recommended topics has been determined by the predetermined value, the procedure returns to step S12 shown in FIG. 3.

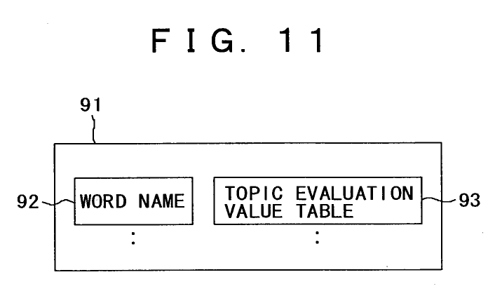

In step S12, the associated-information search block 25 searches for the associated information about the recommended topics determined in step S11 by use of a Web site in the internet. The following describes the Web search processing to be executed in step S12 with reference to the flowchart shown in FIG. 16.

In step S91, the document characteristics database creating block 24 determines whether there is any recommended topic not subject to the Web search among the recommended topics determined in step S1. If any recommended topics not subject to the Web search are found, then the procedure goes to step S92. In step S92, the document characteristics database creating block 24 selects one of the recommended topics not subject to the Web search.

In step S93, the document characteristics database creating block 24 reads the characteristic vector 69 (or the word vector 67) corresponding to the selected recommended topic, and from among the words constituting this characteristic vector 69, selects the top 2 words in evaluation value (or 1 word or 3 or more words) and links them to supply to the associated-information search block 25 as search words.

In step S94, the associated-information search block 25 accesses a search engine in the internet and sends the search words supplied by the document characteristics database creating block 24. In step S95, the associated-information search block 25 acquires the title and URL of the retrieved Web page from the search engine as a result of the Web search.

In step S96, the associated-information search block 25 filters the retrieved search result on the basis of particular words set in advance. To be more specific, the associated-information search block 25 deletes the search results in which the particular words (diaries, proceedings, schedules, events, meetings, or the like) considered to be included in the title of Web page which are considered to be general and not to interest general people. Then, the associated-information search block 25 supplies the remaining search results (title and URL of the Web page) to the document characteristics database creating block 24 as the associated information.

The procedure returns to step S91 to repeat the above-mentioned processing. Then, in step S91, if no more recommended topics not subject to Web search are found among those determined in step S11, the procedure goes to step S97.

In step S97, the document characteristics database creating block 24 determines whether there are any built-in recommended word pairs not subject to web search among the preset built-in recommended word pairs, for example, (travel and hot spring), (sightseeing and hotel), (gourmet and restaurant), (sports and succor), (Sony and new product), or the like. It should be noted that these built-in recommended word pairs may be added or deleted by the user as desired.

If any built-in recommended word pairs not subject to Web search are found, the procedure goes to step S98. In step S98, the document characteristics database creating block 24 selects one of the built-in recommended word pairs not subject to Web search. The procedure goes to step S94 to repeat the above-mentioned processing.

Then, in step S97, if there are no more built-in recommended word pairs not subject to Web search, the Web processing comes to an end, upon which the procedure returns to step S13 shown in FIG. 3.

In step S13, the document characteristics database creating block 24 records the associated information supplied from the associated-information search block 25 into the storage block 49 by relating it with the search words, thereby creating a database. It should be noted that the processing subsequent to step S12 may be executed continuing to the sequence of processes up to step S11 or at a predetermined time without continuation.

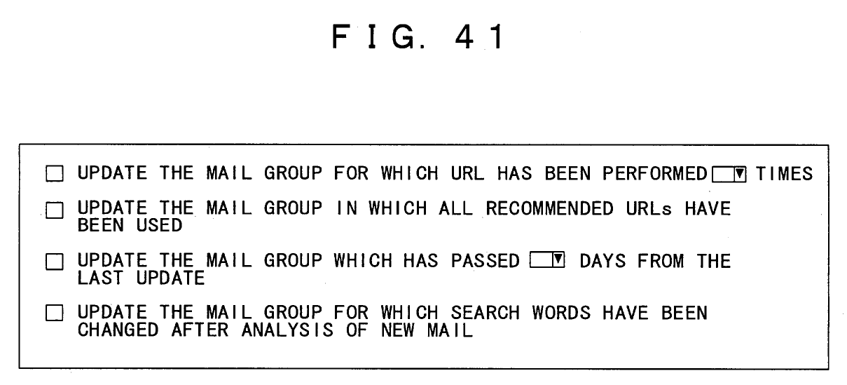

When the above-mentioned database creation processing has been performed, the associated information corresponding to the documents of sent and received electronic mail is accumulated in the database. It should be noted that, although the database creation processing starts when the agent program 1 is executed in this example; the database creation processing may also be started at an arbitrary timing. In addition, the database thus created is updated when predetermined conditions have been satisfied (the update timing will be described later with reference to FIG. 41).

Also, in order for the user to forcibly discontinue the database creation processing, the processing documents may be recorded at the time of discontinuation if discontinuation is requested and the processing may be resumed starting with an unprocessed document.

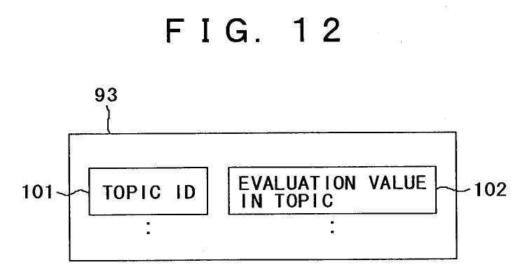

The following describes the associated-information presentation processing by the agent program 1 with reference to the flowchart shown in FIG. 17. Unlike the above-mentioned database creation processing, the associated-information presentation processing is repetitively executed while the agent program 1 is executed.

In step S111, the agent program 1 receives a command from the user through the input block 46 to determine whether the end of the agent program 1 is directed. If the end of agent program 1 is found not directed, the procedure goes to step S112.

In step S112, the event management block 31 monitors the occurrence of an event (such as the completion of the communication of electronic mail by the mailer 2). If no event is found, the procedure returns to step S111 to repeat the above-mentioned processing.

In step S112, if an event is found (for example, the communication of a new electronic mail message), the procedure goes to step S113. In step S113, the event management block 31 notifies the database inquiry block 32 of the event occurrence. In response, the database inquiry block 32 acquires a document (electronic mail sent or received) corresponding to the event occurrence, performs morphological analysis on the retrieved document to extract words (characteristic words) remaining after the deletion of unnecessary words, and computes the evaluation value of each of the extracted words. Consequently, the characteristic vector of the document (in the example, electronic mail) corresponding to event occurrence is computed.

In step S114, the database inquiry block 32 searches the database created by the document characteristics database creating block 24 to compute an inner product between the characteristic vector computed in the process of step S113 and the characteristic vector of each of the topics recorded to the database as a similarity between both the characteristic vectors and extracts those topics in which the computed similarity satisfies predetermined conditions (for example, the similarity is the highest or equal to or higher than a predetermined threshold).

In step S115, by paying attention to the time-dependent transition of evaluation values, the database inquiry block 32 selects the words (important words) which satisfy condition 1 and condition 2 to be described below from among the words included in the topics extracted in step S114. Further, the database inquiry block 32 supplies the associated information about the words (important words) thus selected to the associated-information presentation block 33 via the event management block 31 or directly.

The following describes the above-mentioned conditions with reference to FIG. 18. FIG. 18 shows an exemplary time-dependent transition of the evaluation values of the words accumulated in the database.

For example, let condition 1 be “the word evaluation value should be within predetermined period X (for example, 2 weeks) before the current point of time and less than a predetermined threshold A.” Let condition 2 be “the word evaluation value should be equal to or higher than threshold B with two or more different topics within predetermined period Y (for example, 5 weeks) before the current point of time.” Preferably, condition 3 is added which is “of the two or more different topics in condition 2, the least recent topic and the most recent topic are separated from each other by predetermined period Z or more.”

Use of these conditions allows the selection of words (important words) which are considered highly interesting for the user. Especially, the provision of condition 1 allows excluding the words included in the topics near the current point of time, so that the selection of the associated information (very new information) which is considered having no element of surprise for the user because he is aware thereof may be avoided and the words included in fairly old topics may also be deleted, thereby avoiding the selection of the associated information (very old information) which is considered that the user cannot remember at the current point of time.

Now, referring to FIG. 17 again, the associated information about the occurrence of event (in this example, the communication of electronic mail) has been selected up to this point of processing. In step S112, if the activation of the mailer 2 is detected as the occurrence of event for example, the recommended associated-information determined in the above-mentioned database creation processing is used. At this moment, the important words are displayed on desktop.

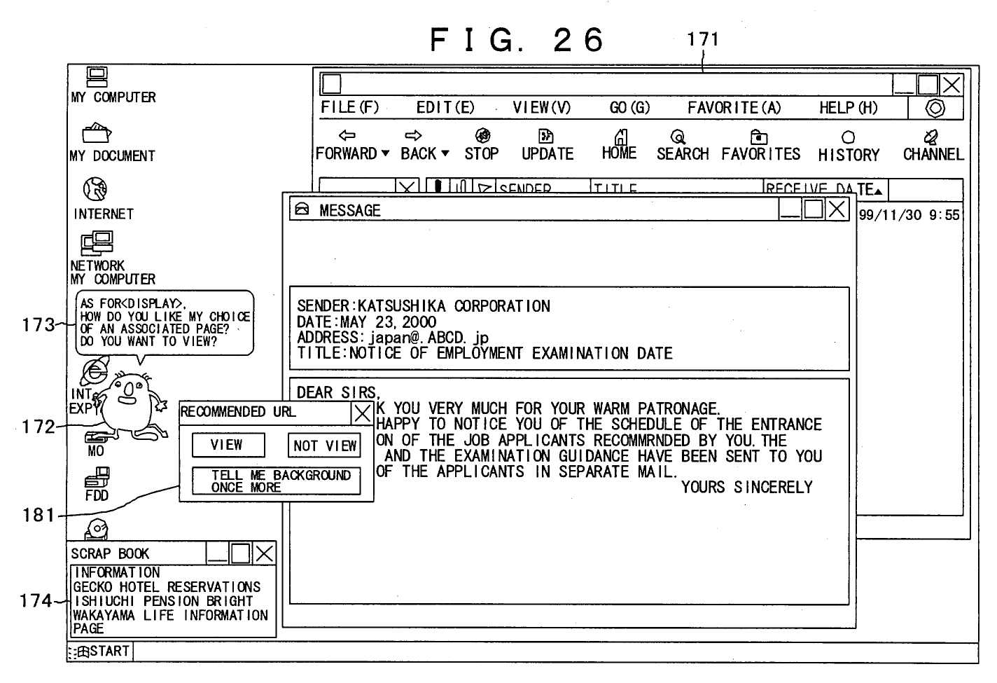

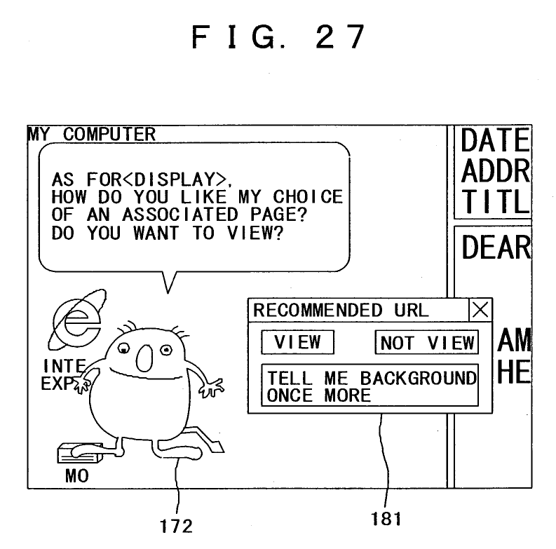

In step S116, the agent control block 13 displays the attribute information of the document in which the words selected in step S115 are included onto desktop as the reason of the selection (or recommendation) and displays an input window 181 (FIG. 26) for inquiring the user whether to display the corresponding associated information on desktop.

It should be noted that, because a topic is composed of one or more grouped documents, it is possible that there are two or more documents in which important words are included (namely, it is possible that there are two or more pieces of attribute information about the documents in which important words are included). Therefore, for example, of the documents in which important words are included, the attribute information about the least recent or most recent document is displayed or the attribute information about a document specified in a given manner is displayed. It is also practicable to display the associated information directly on desktop rather than in the input window 181.

In step S117, in response to a command entered by the user through the input block 46, the agent program 1 determines whether the user has selected “View” button in the input window 181 displayed by the process of step S116. If the user is found having selected “View” button in step S117, then the procedure goes to step S118. It should be noted that, in addition to “View” button and “Not View” button, other information may also be displayed or may not be displayed in the input window 181.

In step S118, the associated-information presentation block 33 displays on desktop the associated information supplied from the database inquiry block 32 via the event management block 31. This associated information may be displayed in single or plural at the same time.

It should be noted that the information to be displayed as the associated information may not be the title of Web page as far as the information is one that is accumulated in the database assigned with keywords. For example, the index of information accumulated in a predetermined database may be displayed, and in response to user's access command, more detail information about this index may be displayed.

In step S119, if the agent program 1, in response to a command entered by the user through the input block 46, determines that the user has directed access to the title of the Web page displayed as the associated information by the process of step S118, the procedure goes to step S120. In step S120, the WWW browser is started up to start accessing the corresponding Web page.

In step S119, if the agent program 1 determines that the user has directed the recording of the title of the Web page displayed as the associated information by the process of step S118, the procedure goes to step S121. In step S121, the agent program 1 records the title and URL of the corresponding Web page to a scrap book window 174 (FIG. 21) which displays presentation log.

In step S119, if a predetermined time is found passed with none of the user commands issued for the title of the Web page displayed as the associated information by the process of step S118, then the procedure returns to step S111 by skipping steps S120 or S121 to repeat the above-mentioned processing.

It should be noted that, if the user is found not having selected “View” button, the procedure returns to step S111 by skipping steps of S118 through S121 to repeat the above-mentioned processing. If the user is found having selected the exit of the agent program 1 in step S1, the associated-information presentation processing comes to an end.

The following describes, as for the associated-information presentation processing, a method of efficiently acquiring electronic mail corresponding to the occurrence of event.

First, most electronic mail send/receive software applicable as the mailer 2 has the following four characteristics with respect to the form of holding electronic mail.

The first characteristic is that one folder in the mailer corresponds to one electronic mail box file in each personal computer.

The second characteristic is that newly received electronic mail is stored in a particular folder, which is added to the end of the corresponding file in each personal computer. Because one file generally stores a plurality of electronic mail messages, a particular character pattern (depending on mailers) is inserted in the boundary between electronic mail messages.

The third characteristic is that the record of each sent electronic mail message is also stored in a file in the like format.

The fourth characteristic is that the file in which communicated electronic mail messages are stored is comparatively large in size (one KB to several hundred KB).

By taking the above-mentioned first through fourth characteristics into consideration, the electronic mail corresponding to the occurrence of event is obtained in the following processes. First, the date/time of update of the electronic mail box file is detected to determine whether any new electronic mail has been added. Next, the electronic mail box file to which new electronic mail has been added is operated line by line from end to start to detect a particular character string indicative of the boundary between the added electronic mail messages. When the character string indicative of the boundary is detected, the data from that position to the end of the electronic mail box file are extracted.

Through the above-mentioned procedure, the electronic mail corresponding to event occurrence can be efficiently obtained.

The following describes, with respect to the abovementioned associated-information presentation processing, a method of avoiding the repetitive presentation of the associated information about the same electronic mail. First, a data structure for recording the message IDs of electronic mail messages with associated information presented is set. Next, when an event occurs, the message ID of the electronic message associated with the event is obtained and the obtained message ID is compared with the data structure. If the same message ID is found in the data structure, the associated information is not presented because the associated information has already been presented for that electronic mail message. On the other hand, if the same message ID is not found in the data structure, the associated information is presented for that electronic mail message and the message ID is recorded to the data structure.

By use of the above-mentioned method, a situation in which the associated information is repetitively presented for the same electronic mail message may be avoided.

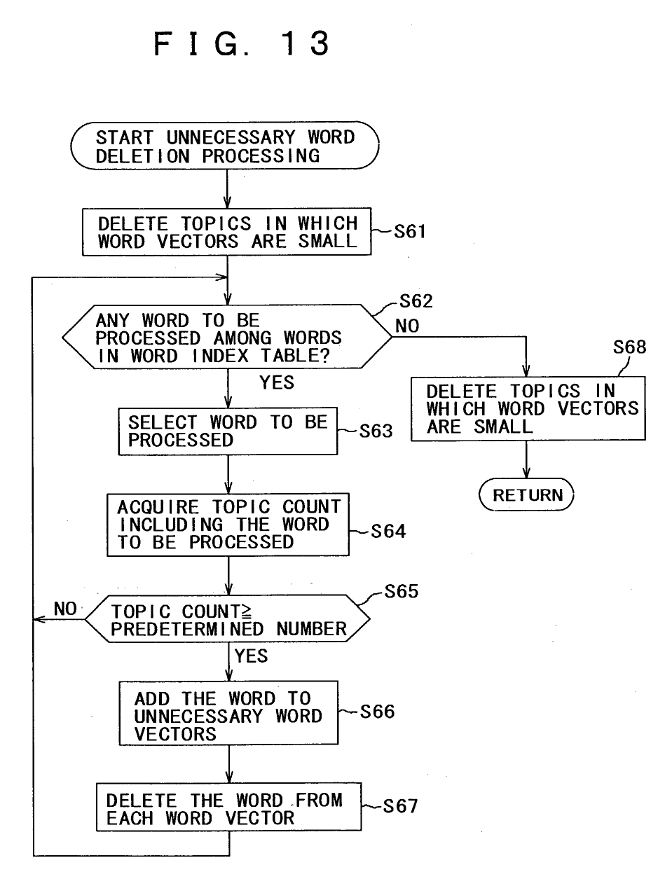

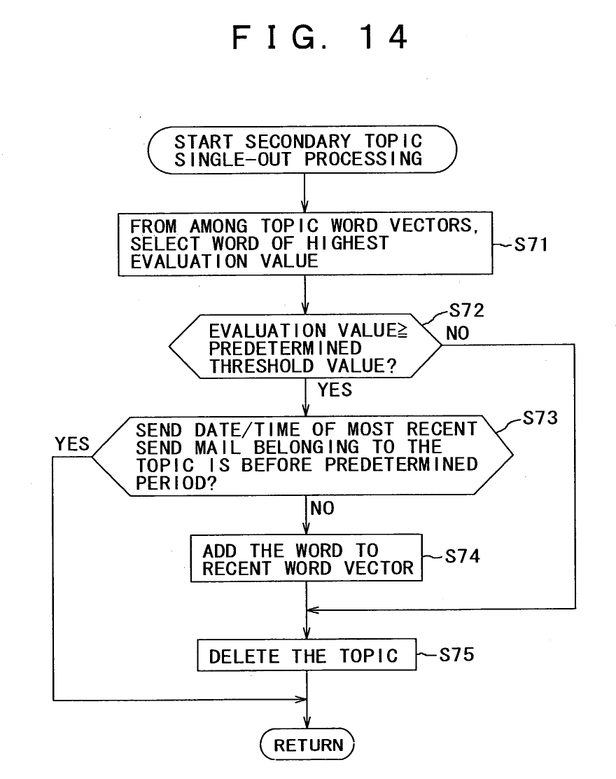

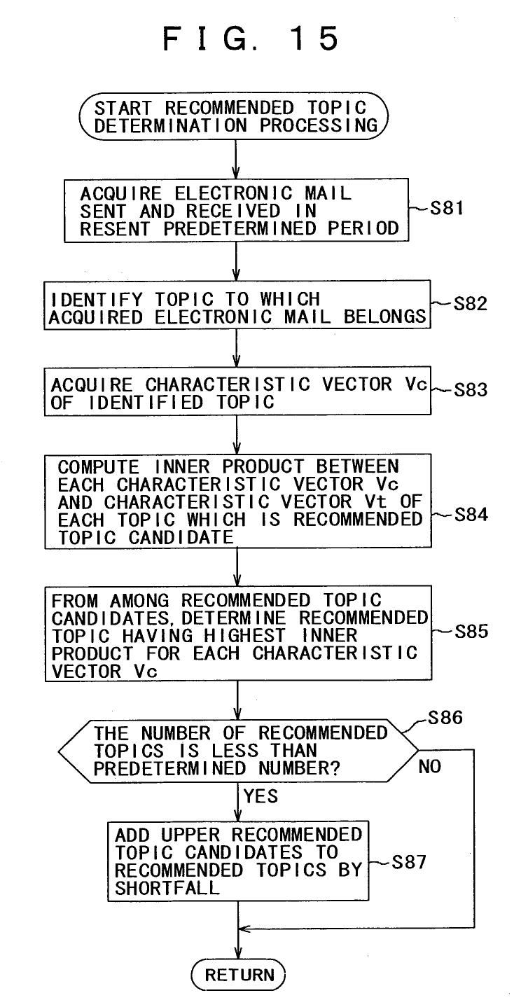

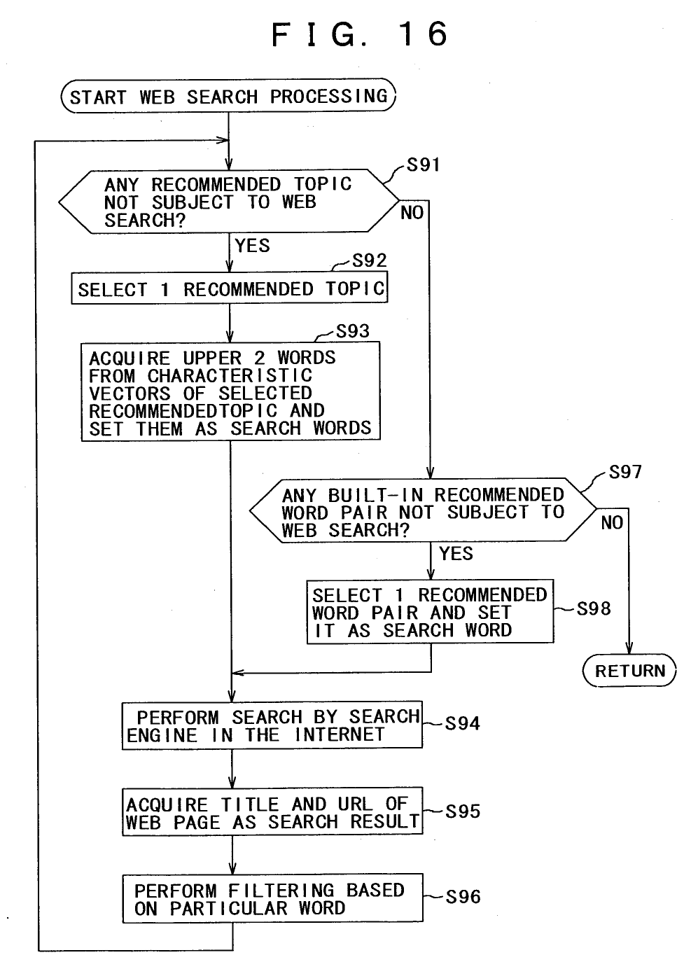

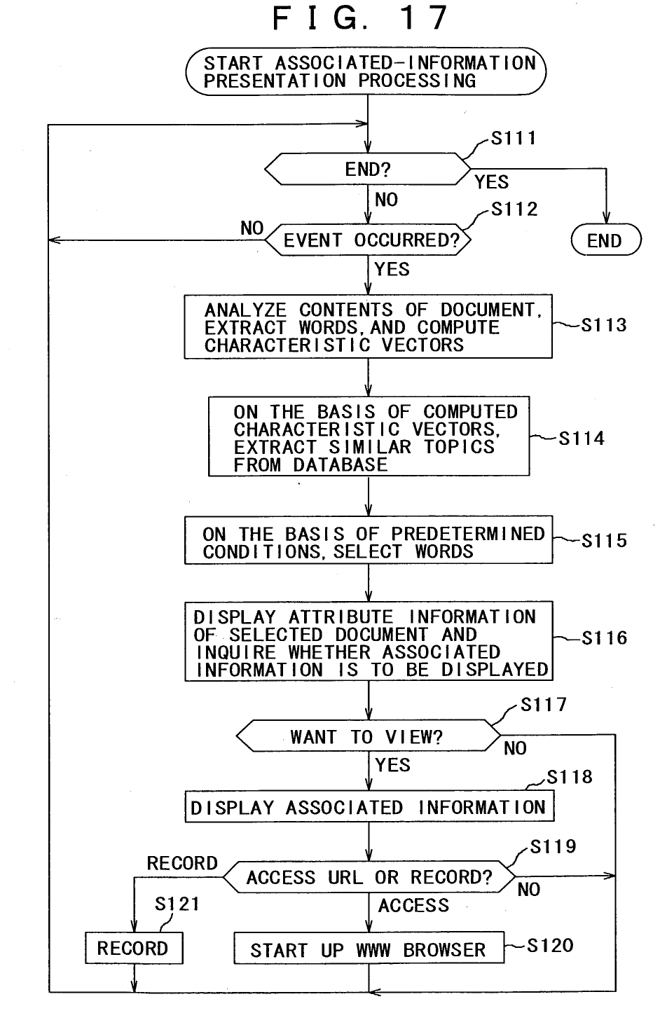

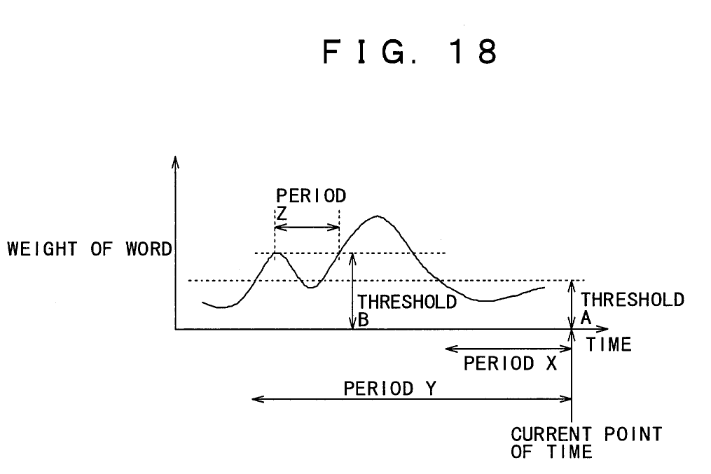

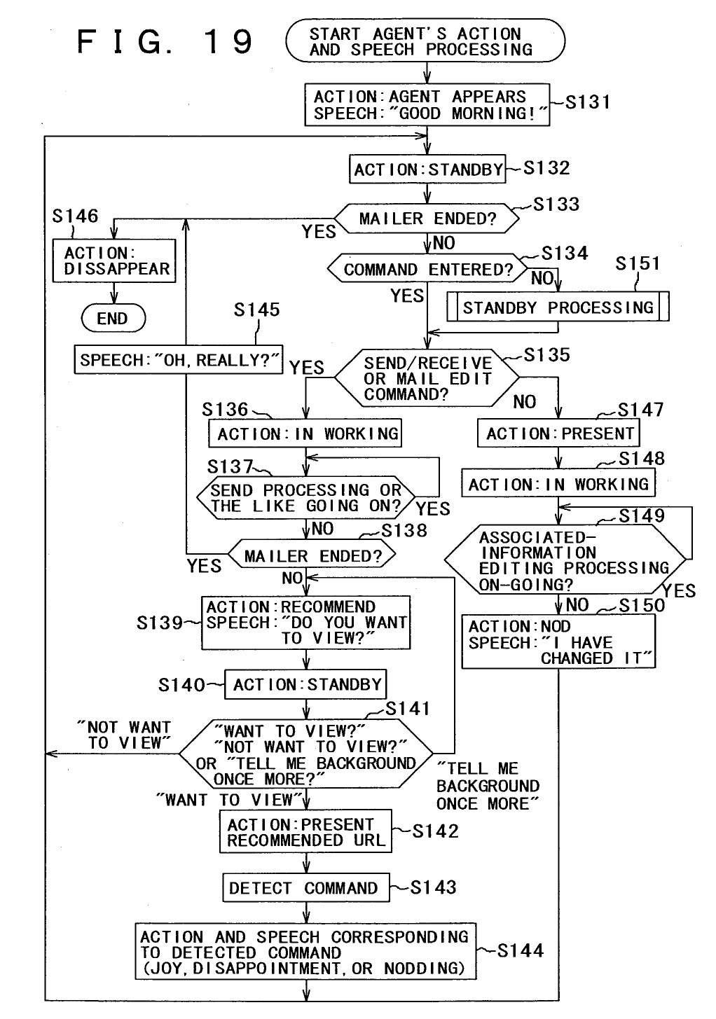

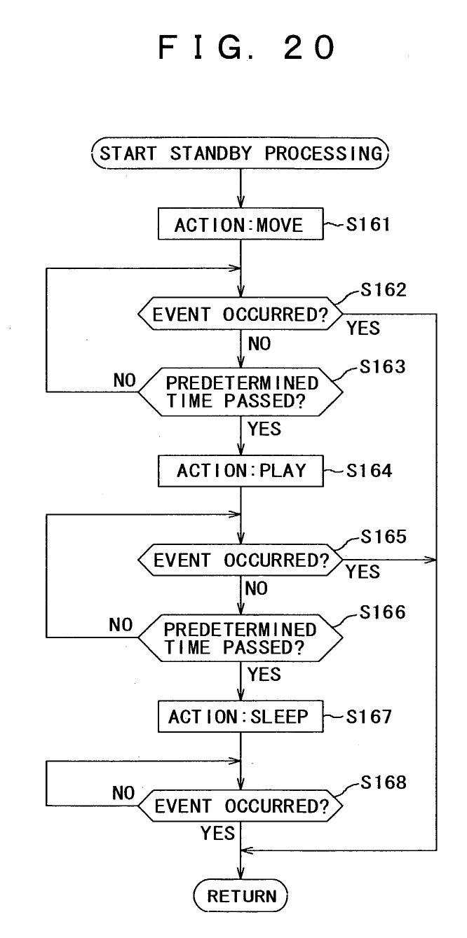

The following details describes the above-mentioned associated-information presentation processing mainly in the action and speech of the agent with reference to the flowcharts shown in FIGS. 19 and 20.

For example, if the mailer 2 is started up with the agent program 1 activated, the agent control block 13 makes an agent 172 appear at a position not overlapping a window (hereafter referred to as a mailer window) 171 of the mailer 2 as shown in FIG. 21 in step S131.

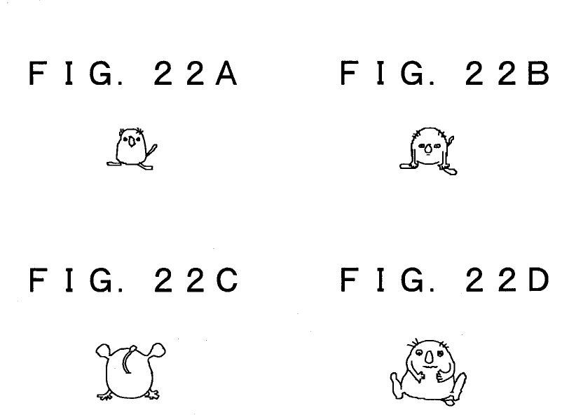

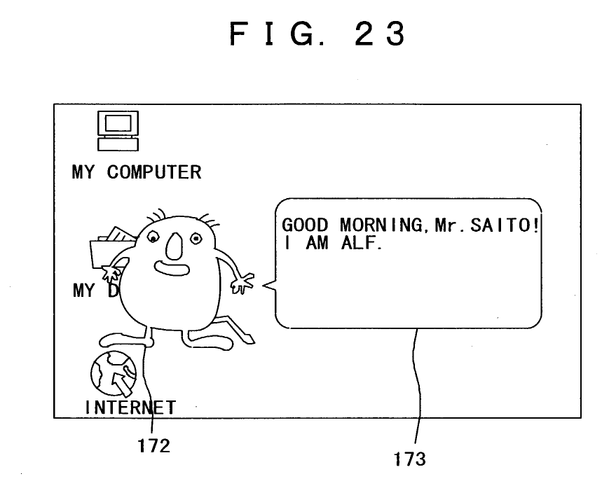

It should be noted that the appearance of the agent 172 is represented by animation in which the agent 172 rolls forward toward the user to appear on desk top, which is effected by sequentially displaying the images shown in FIGS. 22A, 22B, 22C, and 22D in this order. When the agent 172 appears, a balloon 173 in which a speech of the agent 172 is shown and a scrap book window 174 (to be described later) in which the stored associated information is listed are also displayed. In the balloon 173, speeches such as appearance greetings “Good morning, Mr. Saito!” and self introductory remarks “I'm alf.” are displayed for example as shown in FIG. 23.

In synchronization with the speech displayed in the balloon 173, the speech may be audibly outputted by means of a speech synthesizer (not shown) in another language (for example, “Good morning, Mr. Saito! I'm alf.” in English). It should be noted that the language (in this example, Japanese) in which the speech in the balloon 173 is expressed may be the same as the language (in this example, English) in which the speech is audibly outputted. It should also be noted that the subsequent speeches to be displayed in the balloon 173 may also be synchronized with the audible output.

It should be noted that the display or the audible output of the balloon 173 may be set by the agent program 1 appropriately or by the user as desired.

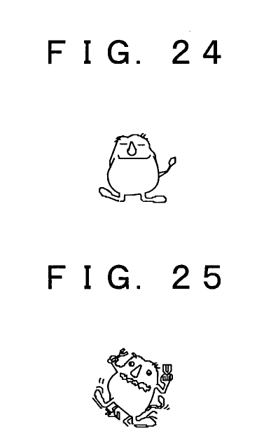

Then, in step S132, the displaying of the agent 172 is shifted to the animation in which the agent 172 is in the standby state (moving one toe up and down with one hands on his back) for example as shown in FIG. 24.

In step S133, in response to a command entered by the user through the input block 46, the agent program 1 determines whether the mailer 2 has ended. If the mailer 2 is found not ended, the procedure goes to step S134.

In step S134 (corresponding to step S112 shown in FIG. 17), the mailer 2 determines whether any command (for example, electronic mail communication command, electronic mail editing command, or associated-information editing command) has been entered by the user. If any one of these commands is found entered, the procedure goes to step S135 to start the processing instructed by the received command.

In step S135, the event management block 31 of the agent program 1 determines whether a command for sending, receiving, or editing electronic mail has been entered. If a command for sending, receiving, or editing electronic mail is found entered, the procedure goes to step S136.

In step S136, the agent control block 13 shifts the displaying of the agent 172 from the standby state shown in FIG. 24 to the animation of a working state (in which the agent quickly moves his hands and feet) as shown in FIG. 25 for example. During this period, the processes of steps S113 through S115 (selecting the associated information for recommendation to the user) shown in FIG. 17.

In step S137, the agent program 1 determines whether the processing (for example, the sending of electronic mail) by the mailer 2 started in response to the entered command is still continuing and repetitively executes this decision process until the processing being executed by the mailer 2 is ended. Namely, until the processing being executed by the mailer 2 is ended, the agent control block 13 keeps the agent 172 in the working state shown in FIG. 25.

If, in step S137, the processing by the mailer 2 is found not continuing, namely the processing being executed by the mailer 2 started in response to the entered command has ended, then the procedure goes to step S138.

In step S138, in response to a command entered by the user through the input block 46, the agent program 1 determines again whether the mailer 2 has ended. If the mailer 2 is found not ended, the procedure goes to step S139.

In step S139 (corresponding to step S116 shown in FIG. 12), if the processing by the mailer 2 in step S137 is for sending electronic mail, the agent control block 13 displays in the balloon 173 of the agent 172 a speech “You've sent mail to Mr. A. You discussed with Mr. A about (title) before. I've found a page associated with (keyword) in the discussion. Do you want to browse that page?” for example.

If the processing by the mailer 2 in step S137 is for receiving electronic mail, the agent control block 13 displays a speech “Now You've received mail from Mr. A. You discussed with Mr. A about (title) before. I've found a page associated with (keyword) in the discussion. Do you want to browse that page?” for example.

If the processing by the mailer 2 in step S137 is for editing electronic mail, the agent control block 13 displays a speech “Now You're writing mail to Mr. A. You discussed with Mr. A about (title) before. I've found a page associated with (keyword) in the discussion. Do you want to browse that page?” for example.

It should be noted that, of the speeches displayed, a part “You discussed with Mr. A about (title) before.” corresponds to the reason why the associated information was selected (or recommended); this reason may also be displayed not in step S139 but after the process (displaying of the associated information) of step S142. Also, the displaying of the reason may be executed any time specified by the user (by preparing a command for asking the reason by menu, for example).

For the presentation of the passing of a certain time by the incorporated timer 31A, only a part of speech “You discussed with Mr. A about (title) before.” for example is displayed instead of displaying a speech indicative of a particular event “You've received mail from Mr. A” for example.

In addition, these balloons 173 may be displayed before or after the presentation of the associated information.

The input window 181 is displayed at a position adjacent to the balloon 173 as shown in FIG. 26 for example. Displayed in the input window 181 are “View” button to be pressed when directing the displaying of the associated information, “Not View” button to be pressed when not displaying the associated information, and “Tell me background once more” button to be pressed when directing the re-displaying of the background in which the associated information was selected (the reason of the selection).

With the input window 181 displayed, the agent control block 13 shifts, in step S140, the displaying of the agent 172 to the animation in which the agent 172 is in the standby state shown in FIG. 26. In step S141 (corresponding to step S117 shown in FIG. 17), the agent program 1 determines whether any one of “View” button, “Not View” button and “Tell me background once more” button in the input window 181. This window may not be displayed.

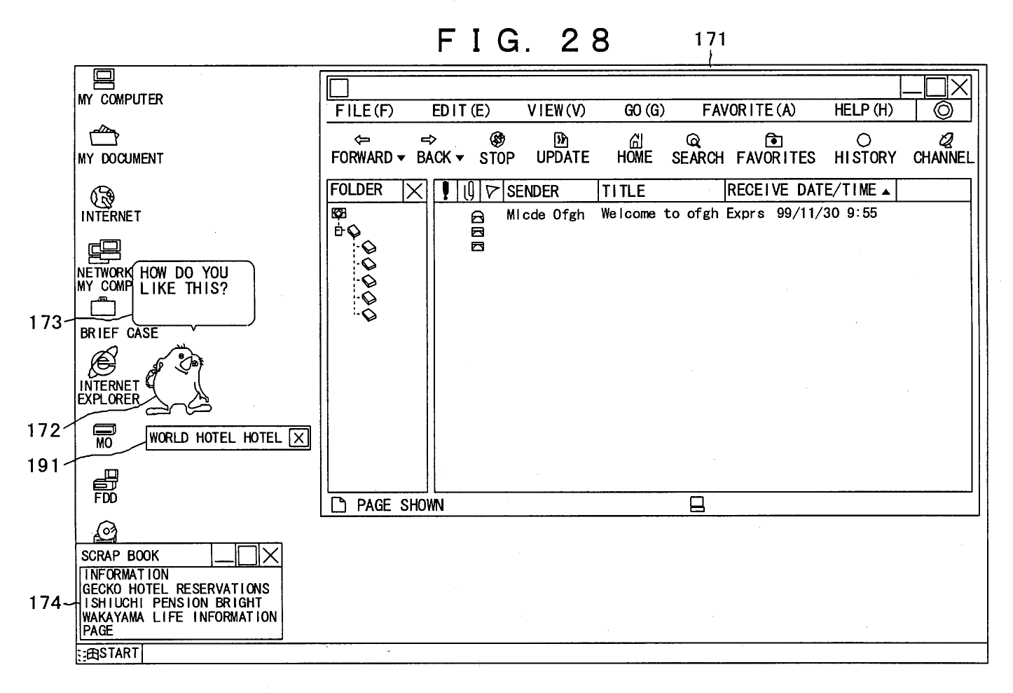

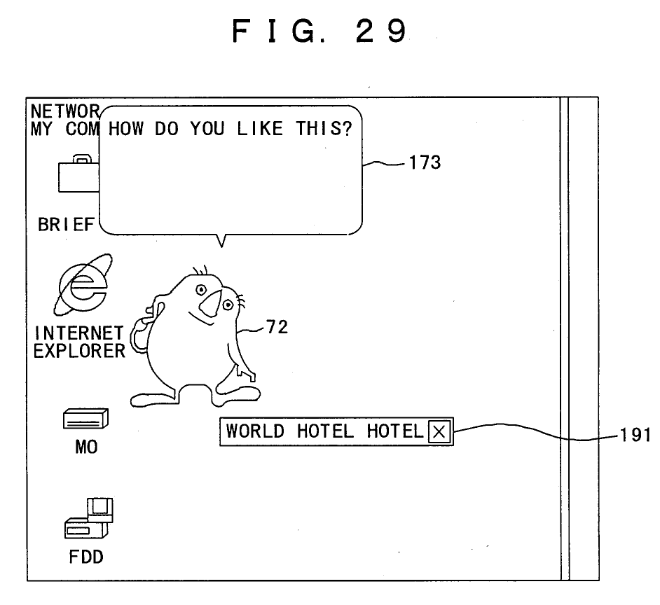

If “View” button in the input window 181 is found pressed in step S141, the procedure goes to step S142. In step S142 (corresponding to step S118 shown in FIG. 17), the agent control block 13 displays a recommended URL 191 as the associated information as shown in FIGS. 28 and 29, shifts the displaying of the agent 172 to the animation in which the agent 172 points at the displayed recommended URL 191, and shows a speech “How do you like this?” in the balloon 173. In the recommended URL 191, the title of a recommended Web page is displayed in usual. Only when the mouse cursor is positioned on the recommended URL 191, the URL is displayed in a superimposed manner. The recommended URL 191 may be moved around by dragging with the mouse cursor.

In step S143 (corresponding to step S119 shown in FIG. 17), the agent program 1 detects a user command issued for the displayed recommended URL 191. This command is for recording, accessing, or deleting for example.

The recording command issued for the recommended URL 191 may be that the recommended URL 191 to be recorded is dragged to the scrap book window 174 and dropped therein or the right-side button of the mouse is clicked to select the record from the displayed menu, for example. Alternatively, all recommended URLs may be recorded automatically. As with an access command and a delete command for example, a method of dragging and dropping the recommended URL in the WWW browser icon or the trash can icon, a method of clicking the right-side button of the mouse to select the recommended URL from the displayed menu, or a method of making the recommended URL clickable, for example.

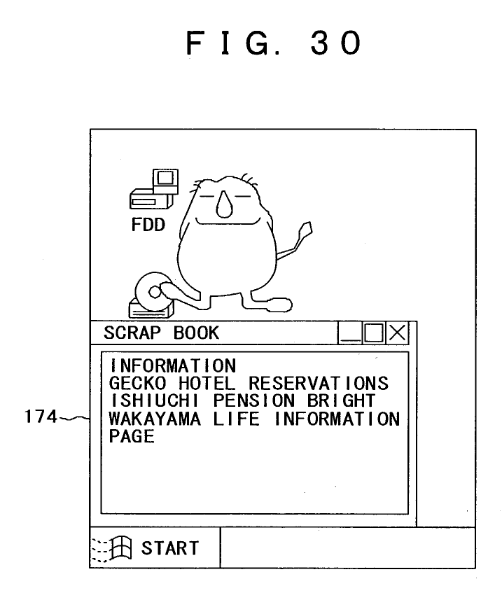

If the record command for the recommended URL 191 is detected in step S143, then the agent control block 13 shifts the displaying of the agent 172 to the animation, as shown in FIG. 30, in which the agent 172 nods in step S144 (corresponding to step S121 shown in FIG. 17). In the scrap book window 174, the title of Web page indicated by the recommended URL 191 to be recorded is additionally displayed.

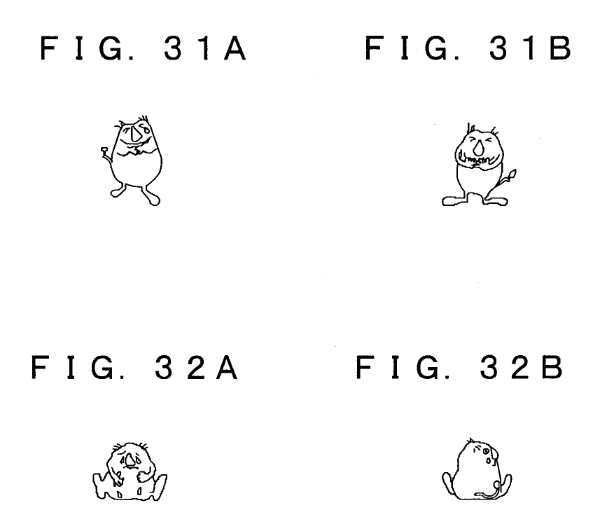

If the access command for recommended URL 191 is detected in step S143, then the agent control block 13 shifts the displaying of the agent 172 to the animation in which the agent 172 rejoices with a smile as shown in FIGS. 31A and 31B for example in step S144 (corresponding to step S120 shown in FIG. 17). In the balloon 173, a speech “Wow!” is displayed and audibly outputted.

If the delete command for the recommended URL 191 is detected in step S143, then the agent control block 13 shifts the displaying of the agent 172 to the animation in which the agent 172 is disappointed with tears as shown in FIGS. 32A and 32B for example in step S144. In the balloon 173, a speech “Oh, No!” is displayed and audibly outputted.

Subsequently, the procedure returns to step S132 to repeat the above-mentioned processing.

It should be noted that, if “Not View” button in the input window 181 is found pressed in step S141, the procedure returns to step S132 to repeat the abovementioned processing. If “Tell me background once more” button in the input window 181 is found pressed in step S141, then the procedure returns to step S139 to repeat the processing of step S139 through step S141.

If the mailer 2 is found ended in step S138, then the procedure goes to step S145. In step S145, the agent control block 13 displays a speech “Oh, really?” indicative of that the agent's unwillingness to the ending in the balloon 173, and at the same time, audibly outputs the speech. Then, in step S146, agent control block 13 wipes out the displaying of the agent 172 (which will be described later with reference to FIG. 37).

In step S135, if a command for directing the editing of the associated information is found entered, the procedure goes to step S147. In step S147, the associated-information presentation block 33 displays an associated-information editing window (not shown). The agent control block 13 shifts the displaying of the standby state shown in FIG. 30 to the state in which the agent is pointing at the associated-information editing window as with the example shown in FIG. 29. Then, when the user starts entering for editing into the associated-information editing window, the agent control block 13 shifts the displaying of the agent 172 from the pointing at the associated-information editing window to the animation in which the agent is working as shown in FIG. 25 in step S148.

In step S149, the agent program 1 determines whether the associated-information editing processing is still going on and repeats this decision until the associated-information editing processing is ended. Namely, until the associated-information editing processing is ended, the agent control block 13 keeps the displaying of the agent 172 in the state of working as shown in FIG. 25.

If, in step S149, the associated-information editing processing is found not continuing, namely, if the associated-information editing processing started in response to the command is found ended, the procedure goes to step S150.

In step S150, the agent control block 13 shifts the displaying of the agent 172 to the animation of nodding as shown in FIG. 30. In the balloon 173, a speech “I've changed it” is displayed and audibly outputted. Then, the procedure returns to step S132 to repeat the abovementioned processing.

If, in step S134, the state in which none of the commands has been entered by user to the mailer 2 continues longer than a predetermined time, the procedure goes to step S151. In step S151, the agent control block 13 shifts the displaying of the agent 172 to the state of moving, the state of playing, and the state of sleeping in this order sequentially every time the predetermined time passes.

The following describes the details of the abovementioned standby processing with reference to the flowchart shown in FIG. 20. It should be noted that the process in each step is executed by the agent control block 13.

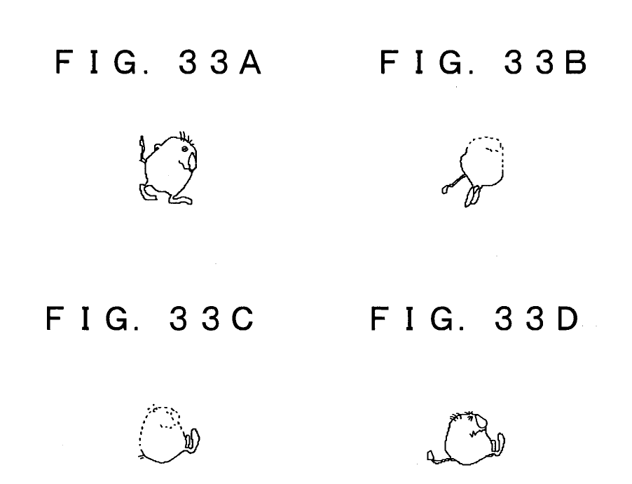

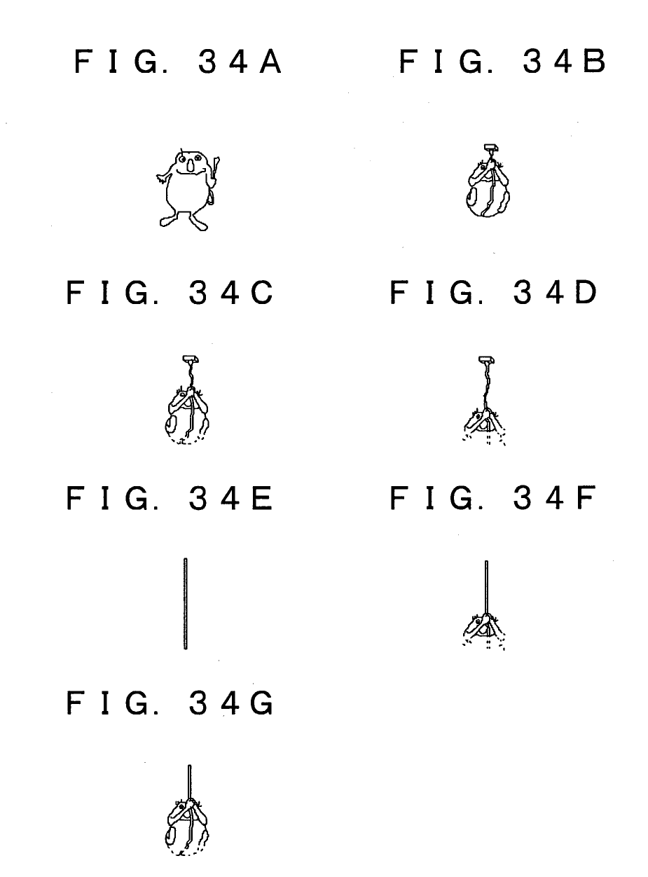

In step S161, the agent control block 13 shifts the displaying of the agent 172 from the state shown in FIG. 24 to the animation in which the agent 172 is represented by use of images shown in FIGS. 33A through 33D or FIGS. 34A through 34G.

The movement of the agent 172 is executed horizontally or vertically on desktop so that the agent is not superimposed on the displayed window. It should be noted that the active window (in this example, the mailer window 171) may be detected and the agent 172 may be moved horizontally or vertically around the active window. When the agent 172 moves horizontally (for example, to the right) on desktop, the images shown in FIGS. 33A through 33D are sequentially used to create an animation effect in which the agent 172 moved as if instantaneously.

To be more specific, the displaying of the agent 172 disappears in a manner in which the body of the agent 172 turns in the direction of movement as shown in FIG. 33A at the movement start position and then the agent 172 jumps in this direction to gradually disappear starting with its head as shown in FIG. 33B. Then, at the movement end position, the agent 172 gradually appears starting with its feet as shown in FIG. 33C, eventually fully appearing as shown in FIG. 33D.

When the agent 172 moves up and down on desktop, the images shown in FIGS. 34A through 34G are sequentially used, for example. To be more specific, at the movement start position, the agent 172 grabs its tail (shaped a receptacle plug in tip) as shown in FIG. 34A and plugs the tip of the tail into the overhead receptacle as shown in FIG. 34B.

Next, the displaying of the agent 172 gradually transforms into a rope starting with the bottom of its body as shown in FIGS. 34C and 34D and moves, in the shape of one rope, to the movement end position as shown in FIG. 34E. At the movement end position, the agent 172 is gradually restored into its original shape starting with its head, eventually having its full body as shown in FIGS. 34F and 34G.

Thus, by representing the movement of the agent 172 by an instantaneous movement or in a rope, the use of the resources (computational amount, memory, or the like) for displaying of the movement may be saved.

Referring to FIG. 20 again, in step S162, the agent control block 13 determines whether an event (the input of a command for electronic mail communication, editing, or associated-information editing for example) has occurred. If no event is found, the procedure goes to step S163.

In step S163, the agent control block 13 determines whether a predetermined time has passed since the shifting of the displaying of the agent 172 to the movement state and repeats the processes of steps S162 and S163 until the predetermined time is found passed. If the predetermined time is found passed, the procedure goes to step S164.

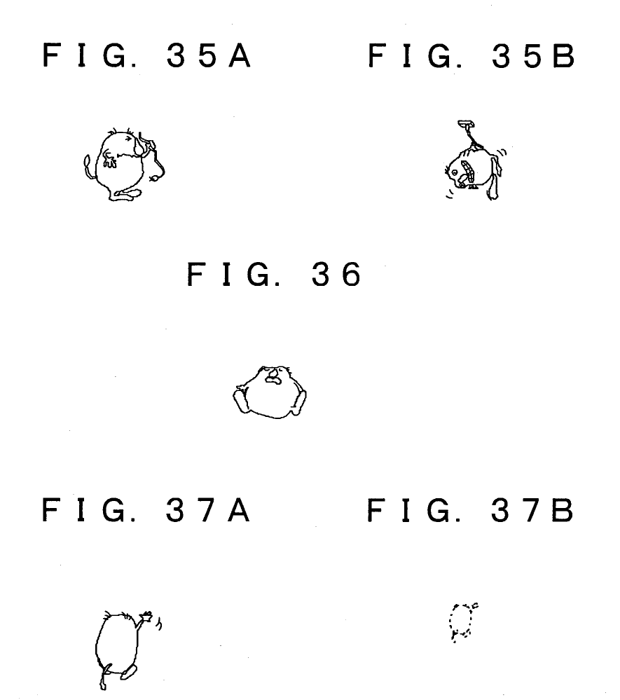

In step S164, the displaying of the agent 172 shifts from the movement state to a play state represented by the images shown in FIGS. 35A and 35B. FIG. 35A shows the state in which the agent 172 is playing with a snake. FIG. 35B shows a state in which the agent 172 plugs his tail into the receptacle overhead and is playing hanged on the plugged tail.

In step S165, the agent control block 13 determines whether an event has occurred. If no event is found, the procedure goes to step S166. In step S166, the agent control block 13 determines whether a predetermined time has passed since the displaying of the agent 172 shifted to the play state and repeats the processes of steps S165 and S166 until the predetermined time is found passed. If the predetermined time is found passed in step S166, then the procedure goes to step S167.

In step S167, the displaying of the agent 172 shifts from the play state to the state of sleeping represented by an image shown in FIG. 36 for example. In step S168, the agent control block 13 determines whether an event has occurred and repeats the decision until an event is found. If, in step S168, an event is found, the standby processing being executed is ended. Then, the procedure goes to step S135 shown in FIG. 19 to repeat the above-mentioned processing.

It should be noted that the standby processing being executed is also stopped if an event is found in step S162 or step S165, upon which the procedure goes to step S135 to repeat the above-mentioned processing.

Although not shown in the flowchart shown in FIG. 20, if the mailer 2 is found ended during the execution of the standby processing, this standby processing being executed is also ended, upon which the procedure goes to step S146. Likewise, if the mailer 2 is found ended in step S133, the procedure goes to step S146.

In the step S146, the agent control block 13 shifts the displaying of the agent 172 to a disappearing state represented by the images shown in FIGS. 37A and 37B for example. FIG. 37A shows a state in which the agent 172 leaves into the background waving its hand. FIG. 37B shows a state in which the agent 172 becomes gradually smaller and eventually disappears.

It should be noted that, as the agent 172 disappears, the balloon 173, the scrap book window 174, and the recommended URL 191 also disappear.

Thus, according to the invention, the words of high evaluation values (important words) are extracted from documents such as electronic mail messages for example and the agent 172 acts in response to a sequence of processes for recommending the associated information, thereby making the user feel reliability and affinity with the agent 172.

It should be noted that the above-mentioned actions of the agent 172, displaying of speeches in the balloon 173, and audible output of these speeches are applicable to not only the agent program 1 according to the invention but also other application programs such as the help screens of computer games and word processors for example. Moreover, these are also applicable to characters displayed on the monitor screens of television receivers, video cameras, and car navigation systems for example.

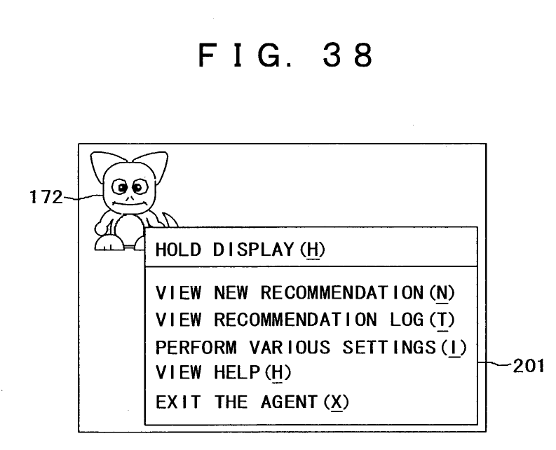

In the case where one personal computer is shared by two or more users, a plurality of agents 172 may be arranged, each agent 172 to each user (FIG. 38). The agent 172 may be created or edited by the user for his liking.

Further, in a case where one user uses the agent program 1 on two or more personal computers, the same agent 172 may be displayed on these plural personal computers.

It should be noted that, in the above description, the agent 172 is always displayed while the agent program 1 is executed; however, the timing of the displaying of the agent 172 may be changed to the displaying only at presenting the recommendation of associated information for example.

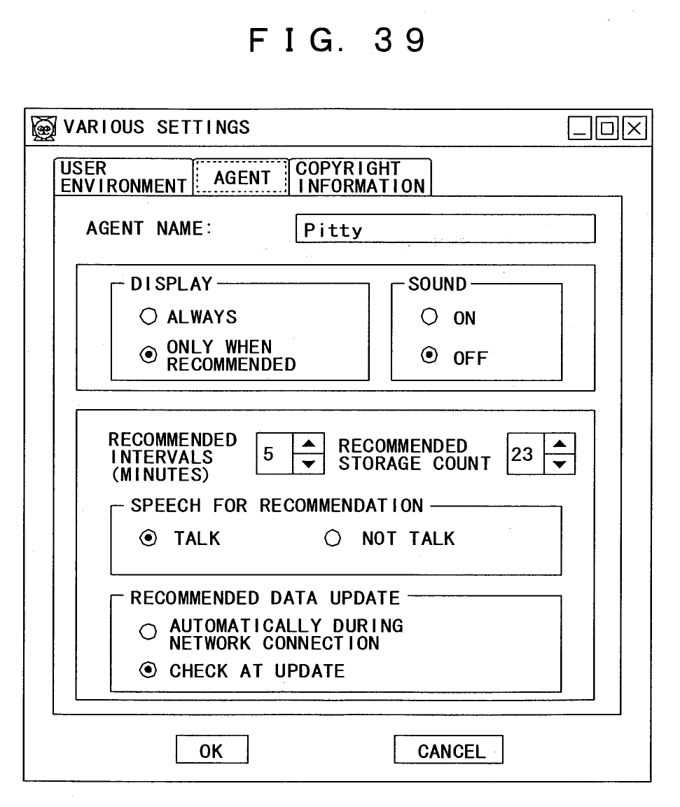

To be more specific, the setting screen as shown in FIG. 39 is displayed by displaying a menu box 201 as shown in FIG. 38 by clicking the right button of the mouse when the agent program 1 is being executed to select “Perform various settings” from the menu box.

In the setting screen shown in FIG. 39, a plurality of tabs are arranged. When tab “Agent” is in active mode, such items that the user can select or enter as agent name, display, effect sound, recommended interval, recommended storage count, speech for recommendation, and recommended data update.

The user can enter desired selections for these items (agent name, or the like) to set the state of the displaying of the agent 172 and the balloon 173 and set the recommended interval and storage count of the recommended associated information as desired.

The following describes the timing of updating the database by the accumulation block 11. The database is created by the above-mentioned database creation processing. If any of the first, second, and third situations described below is encountered, the database update processing is executed.

The first situation is that, if a predetermined time has passed since the creation or update of the database, the associated information in the database becomes obsolete, so that the database must be updated.

The second situation is that, if a predetermined ratio of the associated information stored in the database has been presented, the same associated information in the database is repetitively presented or the associated-information to be presented runs short, so that the database must be updated.

The third situation is that, if the document used for characteristics extraction is electronic mail, the repetition of the communication of electronic mail changes the contents of the document, so that the database must be updated.

If any of the above-mentioned situations is encountered (for example, the event management block 31 monitors the timer 31A and a predetermined period has passed), the user may be prompted to update the database or the database may be updated automatically. It is also practicable to automatically update the database in a timed relation specified by the user as desired.

The following describes the database update processing with the above-mentioned three situations considered with reference to the flowchart shown in FIG. 40. This database update processing, one of the processing operations to be executed by the agent program 1, is started when the agent program 1 is started and repeated until the agent program 1 is ended. It is assumed that, before this database update processing starts, the above-mentioned database creation processing have been executed- and the created database already exist.

In step S181, the accumulation block 11 of the agent program 1 determines whether it is necessary to update the created database and waits until the update is found necessary. The criteria of this decision is set by the user beforehand by use of a user interface screen as shown in FIG. 41 for example. In the example shown in FIG. 41, four conditions are presented. The user specifies each of these conditions by checking the box (check box) on the left. It should be noted that, in the first condition, the count may be set, and in the third condition, the number of days may be set.

If, in step S181, updating is found necessary, the procedure goes to step S182. In step S182, the accumulation block 11 determines whether the database is set for automatic updating. If the database is found not set for automatic updating, then the procedure goes to step S183. On the other hand, if the database is found set for automatic updating in step S182, step S183 is skipped.

In step S183, the presentation block 12 of the agent program 1 notifies the user of the necessity for updating the database and determines whether the updating of the database has been instructed by the user in response to the notification. If the instruction is found entered by the user, the procedure goes to step S184. If the instruction is found not entered, the procedure returns to step S181 to repeat the above-mentioned processing.

In step S184, the accumulation block 11 of the agent program 1 updates the database. To be more specific, the blocks, the document acquisition block 21, the document attribute processing block 22, and the document contents processing block 23, detect an electronic mail box file (often with a particular extension mbx for example), acquires its update date/time, compares the obtained update date/time with the update date/time obtained last, and if mismatches are found in date/time and file size, determines that the file has been updated, thereby extracting the additions or changes. In this case, a series of analyses in the file such as electronic mail grouping, header analysis, morphological analysis and characteristic vector computation are conducted, and the important words obtained as a result of these analyses are supplied to the associated-information search block 25.

It should be noted that, if there is no change in mail groups (topics) (namely, there is no new electronic mail added to a predetermined topic), and as a result of the analyses, the important word (search keyword) before the updating is the same as the important word after the updating, the searching operation for the associated information by the associated-information search block 25 may be skipped.

Alternatively, if a certain period has passed without involving a change in all electronic mail groups, the search words used at the last time consisting of the words having the first and second evaluation values may be replaced by the search words consisting of words having the third and fourth evaluation values for example, to obtain a search result.

Alternatively still, a search operation based on only built-in word pairs may be executed to update the database.

It should be noted that, if a search engine in the internet is used for searching for the associated information, whether or not the personal computer is connected to the Internet is determined. If the personal computer is found not connected to the Internet, the search for the associated information may not be executed, and when the personal computer is connected to the Internet later, the user may be asked to execute the search for the associated information.

As for the condition “in order to avoid the repetitive recommendation (presentation) of the same associated information, the database must be updated when the associated information of a particular mail group have been recommended by the number of times equal to or higher than a predetermined value,” the following processing is executed in order to prevent the repetitive recommendations from the same mail group when selecting a mail group (topic) having a high similarity with the obtained electronic mail.

A recommendation priority is given to each mail group itself (for example, the maximum value of the evaluation values of the characteristic words within each mail group is used as the priority value of that mail group and the resultant priority values aligned in the descending order of all mail groups provide an order of priorities) and a mail group once recommended is turned to the end of the priority sequence. By doing so, the frequency of recommendation from the same mail group if within a range of similarity, may be decreased. In this method, only the priorities are changed, so that if the associated information has been searched for and prepared beforehand in large quantities, the frequency of recommendation from the same mail group may be decreased and the information itself may be used without running short.

With respect to the above-mentioned method, the range of extracting similar topics may be changed in accordance with the amount of documents in topics to be used for characteristics extraction. To be more specific, several levels of similarity ranges are set in accordance with the amount of documents or data size of each topic from which characteristics are extracted. For example, if the amount of documents included in a particular topic is within 10 files, similarity is set to 0.01 or higher; if the amount of documents is 11 files or more and less than 50 files, similarity is set to 0.03 or higher; if the amount of document is 5150 files or more, similarity is set to 0.05 or higher. Alternatively, if the amount of documents of a particular topic is less than 500 KB, similarity is set to 0.01 or higher, and if the amount of documents is 500 KB or more, similarity is set to 0.02 or higher.

Then, within the range of similarities set beforehand, the retrieved associated information is presented from the topics in the order or their priorities. Consequently, when the contents of the database are updated due to the reduction in the amount of documents, the range of similarities changes, thereby preventing a situation from occurring in which the associated information runs short because the similarity range is too narrow or the associated information not properly related to the user is displayed because the similarity range is too wide.

As described above, in the database update processing, only the added documents and changed documents are processed, so that the processing time is significantly shorter than the case in which the database creation processing is repetitively executed.

The agent program 1 according to the invention may also be operated for such documents having time stamps as attribute information as documents including chats, electronic news, electronic bulletin boards, texts obtained by converting voice signals, in addition to the above-mentioned electronic mail communicated by the mailer 2 and the documents edited by the word processor program 3.

The agent program 1 for executing the abovementioned sequence of processes is built in a personal computer beforehand or installed therein from a recording medium.

The above-mentioned sequence of processing operations may also be executed by hardware; usually, these processing operations are executed by software. To have software execute the above-mentioned sequence of processing operations, the agent program 1 constituting this software is installed, from a recording media, into a computer assembled in a dedicated hardware unit or a general-purpose personal computer for example capable of executing various functions by installing various programs.

The program storage media for storing programs which are installed in a computer and made executable by the computer may be constituted by package media including the magnetic disk 52 (including flexible disk), the optical disk 53 (including CD-ROM (Compact Disk-Read Only Memory and DVD (Digital Versatile Disk)), the magneto-optical disk 54 (including MD (Mini Disk), or the semiconductor memory 55, or by the ROM 42 or the hard disk constituting the storage block 49 for storing programs temporarily or permanently. As required, programs are stored in program storage media by use of wired or wireless communication medium such as a public switched network, a local area network, the Internet, or a digital satellite broadcasting through an interface such as a rooter and a modem for example.

It should be noted that the steps describing each program recorded on the recording media may include herein not only the processing which is executed in a time-dependent manner in accordance with a predetermined sequence but also the processing which is executed in a parallel or discrete manner.

While the preferred embodiments of the present invention have been described using specific terms, such description is for illustrative purposes only, and it is to be understood that changes and variations may be made without departing from the spirit or scope of the appended claims.

What is claimed is:

1. An information processing apparatus having:
database creating means for classifying existing document information into groups and creating a database having associated information about each of said groups;
search means for searching predetermined document information for characteristic words; and
presenting means for presenting, of said associated information created by said database creating means, associated information associated with said characteristic words searched by said search means, said database creating means comprising:
selecting means for selecting, of document information about all of said existing document information, said existing document information to be classified into said groups;
classifying means for classifying said existing document information selected by said selecting means into said groups;
single-out means for singling out at least one of said groups having said existing document information;
acquiring means for acquiring associated information about at least one of said groups having said existing document information; and
accumulating means for accumulating said associated information acquired by said acquiring means by relating said associated information with said groups.

2. An information processing apparatus according to claim 1, wherein said existing document information is electronic mail sent or received in the past and said predetermined document information is sent or received electronic mail.

3. An information processing apparatus for classifying existing document information into groups and creating a database having associated information about each of said groups, said information processing apparatus comprising:
selecting means for selecting, of document information about all of said existing document information, said existing document information to be classified into said groups.

4. An information processing apparatus according to claim 3, wherein said selecting means selects, of all of said existing document information, said existing document information communicated with a partner of communication satisfying a communication partner condition for determining the communication partner of said existing document information.

5. The information processing apparatus according to claim 3, wherein said selecting means determines, communication partner condition on the basis of at least one of communication frequency within a predetermined period, communication date/time, total number of communications, and address attribute condition.

6. An information processing method for an information processing apparatus for classifying existing document information into groups and creating a database having associated information about each of said groups, comprising the step of:
selecting, of all of said existing document information, said existing document information to be processed for classifying into said groups.

7. A recording medium storing a computer-readable program for classifying existing document information into groups and creating a database having associated information about each of said groups, comprising the step of:
selecting, of all of said existing document information, said existing document information to be processed for classifying into said groups.

8. A program for having a computer for classifying existing document information into groups and creating a database having associated information about each of said groups execute the step of:
selecting, of all of said existing document information, said existing document information to be processed for classifying into said groups.

9. An information processing apparatus for creating a database having associated information about each of groups of existing document information, comprising:
classifying means for classifying said existing document information into said groups; and
single-out means for singling out at least one of said groups having said existing document information.

10. An information processing apparatus according to claim 9, wherein said single-out means deletes said groups having said existing document information which does not satisfy a constituent condition.

11. An information processing apparatus according to claim 9, wherein said single-out means changes said constituent condition in correspondence with the number of said groups.

12. An information processing method for an information processing apparatus for creating a database having associated information about each of groups of existing document information, comprising the step of:
classifying said existing document information into said groups.

13. A recording medium storing a computer-readable program for creating a database having associated information about groups of existing document information, comprising the step of:
classifying said existing document information into said groups.

14. A program for having a computer for creating a database having associated information about each of said groups of existing document information execute the step of:
classifying said existing document information into said groups.

15. An information processing apparatus for classifying existing document information into groups and creating a database having associated information about each of said groups, comprising:
acquiring means for acquiring associated information about at least one-of said groups having said existing document information.

16. An information processing apparatus according to claim 15, wherein said acquiring means includes:
linking means for linking all of said existing documents classified into the same one of said groups to create a linked document;
morphological analyzing means for decomposing said linked document into words by morphological analysis;
evaluation value assigning means for assigning an evaluation value weighted in accordance with a predetermined condition to each of said words obtained by said morphological analyzing means;
word vector setting means for setting a word vector constituted by said words assigned with said evaluation values to each of said groups; and
search means for acquiring said associated information by use of a search engine on a network by using, as search words, said words constituting said word vector for each of said groups.

17. An information processing apparatus according to claim 16, wherein said linking means links all of said existing documents classified into said same group by inserting a predetermined character string between said sent existing document and said received existing document to create said linked document.

18. An information processing apparatus according to claim 16 wherein said evaluation value assigning means assigns an evaluation value to each of the words belonging to said sent existing document, said evaluation value being weighted heavier than an evaluation value to be assigned to each of the words belonging to said received existing document.

19. An information processing apparatus according to claim 16, wherein said evaluation value assigning means assigns, to each of said words, an evaluation value weighted in accordance with at least one of the number of said existing documents to which each of said words belongs and the length of said existing documents.

20. An information processing apparatus according to claim 16, wherein said word vector setting means deletes unnecessary words from said word vector.

21. An information processing apparatus according to claim 20, wherein said word vector setting means specifies any words, belonging to in excess of a predetermined number of said groups, as unnecessary words and deletes said unnecessary words from said word vector.

22. An information processing apparatus according to claim 16, further comprising:
single-out means for singling out at least one of said groups having said existing document information,
wherein said single-out means removes any of said singled-out groups in which the number of elements of the corresponding word vector is lower than a predetermined value.

23. An information processing apparatus according to claim 22, wherein said word vector setting means, as a result of removing said group having the number of elements of the corresponding word vector lower than said predetermined value by said single but means, deletes unnecessary words from the word vector corresponding to said singled-out group.

24. An information processing apparatus according to claim 22, wherein said single-out means also deletes said group in which the number of elements of the corresponding word vector decreased below said predetermined value as a result of the removal of the unnecessary words by said word vector setting means.

25. An information processing apparatus according to claim 22, wherein, after the removal of said unnecessary words from said word vector by said word vector setting means and the removal of said group in which the number of elements of the corresponding word vector is lower than said predetermined value by said single-out means, said evaluation value assigning means assigns said evaluation value weighted in accordance with said predetermined condition to each of said words.

26. An information processing apparatus according to claim 22, wherein said single-out means also deletes any of said groups in which a maximum value of the evaluation values assigned to the words constituting the corresponding vector is equal to or more than a predetermined value, and in which a most recent communication date/time of said classified existing documents is within a predetermined period.

27. An information processing apparatus according to claim 16, further comprising:
search means for searching predetermined document information for a characteristic word,
wherein said search means links a plurality of words assigned with higher evaluation values among said word vectors corresponding to said groups and uses the linked words as search words.

28. An information processing apparatus according to claim 27, wherein said search means deletes any of search results, obtained by said search engine, which includes a predetermined character string.

29. An information processing apparatus according to claim 27, wherein said search means uses a preset word as a search word.

30. An information processing method for an information processing apparatus for classifying existing document information into groups and creating a database having associated information about each of said groups, comprising the step of:
acquiring associated information about at least one of said groups having said existing document information.

31. A recording medium storing a computer-readable program for classifying existing document information into groups and creating a database having associated information about each of said groups, comprising the step of:
acquiring associated information about at least one of said groups having said existing document information.

32. A program for having a computer for classifying existing document information into groups and creating a database having associated information about each of said groups execute the step of:
acquiring associated information about at least one of said groups having said existing document information.

33. An information processing apparatus for classifying electronic mail sent or received in the past into groups and presenting associated information about each of said groups, said information processing apparatus comprising:
selecting means for determining, on the basis of the total number of said electronic mail sent or received in the past, a date/time condition and an address attribute condition of said electronic mail to be selected, and on the basis of said date/time condition and said address attribute condition, selecting said electronic mail sent or received in the past;
of said selected electronic mail, single-out means for classifying associated electronic mail into groups, determining a constituent mail count condition of said groups on the basis of the total number of said groups, and singling out any of said groups on the basis of said constituent mail count condition;
deleting means for performing morphological analysis on said electronic mail belonging to said singled-out groups to create a word vector, and among the words constituting said word vector, deleting words belonging to many of said groups from said word vector as unnecessary words;
removing means for assigning an evaluation value to each of said words belonging to said word vector, and in said groups including said electronic mail of which date/time of transmission or reception is after a predetermined date/time, handling, as a recent word, each word having an evaluation value over a predetermined threshold included in said word vector, thereby removing any of said groups in which the evaluation value of said recent word occupies a higher position of said word vector; and
presenting means for searching for any of said groups that is similar to sent or received electronic mail and presenting associated information about the searched group.

34. An information processing apparatus for classifying electronic mail sent or received in the past into groups and presenting associated information about said groups, said information processing apparatus comprising:
on the basis of the total number of electronic mail sent or received in the past, determining means for determining a date/time condition and an address attribute condition of said electronic mail to be selected;
selecting means for selecting, on the basis of said date/time condition and said address attribute condition, said electronic mail sent or received in the past; and
classifying means for classifying the selected electronic mail said groups.

35. An information processing apparatus for classifying electronic mail sent or received in the past into groups and presenting associated information about said groups, said information processing apparatus comprising:
on the basis of the total number of said groups, single-out means for determining a constituent mail count condition for said groups, on the basis of said constituent mail count condition, singling out any of said groups.

36. An information processing apparatus for classifying electronic mail sent or received in the past into groups and presenting associated information about said groups, said information processing apparatus comprising:
creating means for creating a word vector from said electronic mail belonging to said groups;
deleting means for-deleting, of the words constituting said word vector, words belonging to many of said groups as unnecessary words; and
on the basis of said word vector, search means for searching for said associated information about said groups.

37. An information processing apparatus for classifying electronic mail sent or received in the past into groups and presenting associated information about said groups, said information processing apparatus comprising:
creating means for creating a word vector from said electronic mail belonging to said groups;
assigning means for assigning an evaluation value to each of words included in said word vector; and
in said groups including said electronic mail of which date/time of transmission or reception is after a predetermined date/time, removing means for handling, as a recent word, each word having an evaluation value over a predetermined threshold included in said word vector, thereby removing any of said groups in which the evaluation value of said recent word occupies a higher position of said word vector.
